(19) United States
(12) Patent Application Publication
(10) Pub. No.: US 2012/0246744 A1
(43) Pub. Date: Sep. 27, 2012

(54) OPERATION CONTROL DEVICE, OPERATION CONTROL METHOD, LICENSE PROVISION SYSTEM, OPERATION CONTROL PROGRAM, AND RECORDING MEDIUM

(76) Inventor: Hiroki Kagawa, Osaka-shi (JP)

(21) Appl. No.: 13/513,931

(22) PCT Filed: Nov. 17, 2010
(86) PCT No.: PCT/JP2010/070465

§ 371 Date: Jun. 5, 2012

(30) Foreign Application Priority Data
Dec. 29, 2009 (JP) 2009-299204

(51) Int. Cl. G06F 21/24

(52) U.S. Cl. 726/32

(57) ABSTRACT

A license server (400) controls each user terminal (100) on the basis of a license permitting a user terminal (100) to reproduce any content and permitting another user terminal (100) to reproduce a content identical to a content that is being reproduced by the above user terminal (100). A service use status change detecting section (411) detects that the user terminal (100) that is permitted to reproduce any content has switched its reproducing content. A license authorization control section (412), in the case where such a switch has been detected, switches a content, which the other user terminal (100) is permitted to reproduce, to a content being reproduced by the user terminal (100) that is permitted to reproduce any content.

### TECHNICAL FIELD

The present invention relates to an operation control device, an operation control method, and an operation control program each for controlling a content reproduction operation of a terminal on the basis of a license. The present invention further relates to a license provision system for providing such a license and to a computer-readable recording medium on which the above operation control program is recorded.

### BACKGROUND ART

Recent years have witnessed an increase in the number of video contents and audio contents distributed over a network line such as the Internet or through a broadcast wave.

Such video contents and audio contents include a large number of contents, such as pay contents, that each permit only a particular person to view or listen to the content. An authorized user is normally granted a license so that only an authorized person can view a video or listen to an audio.

As portable terminals have become cheaper and higher in performance, an increasing number of users (i) own both a portable terminal, such as a mobile telephone, that is capable of content reproduction and a fixed terminal such as a digital television, and thus (ii) view a content on the portable terminal while being away from home and on the fixed terminal at home. Further, a large number of users have a plurality of fixed terminals set up at home.

Viewing a pay content on a plurality of terminals typically requires making an agreement on license use for each terminal regardless of whether the terminal is a portable terminal or a fixed terminal. There is, on the other hand, a distribution service that permits a user to, under a certain condition, view a pay content on a plurality of terminals on the basis of a single license agreement. Such a distribution service can be provided with use of, for example, any of the techniques disclosed in the documents below.

Patent Literature 1 discloses a license server that permits a user to view a content on a plurality of terminal devices. The license server of Patent Literature 1 achieves such an arrangement by (i) creating, from a license granted to the user, a number of sub-licenses which number is equal to the number of terminal devices, the sub-licenses allowing respective use conditions (for example, the number of reproduction) to be set independently of one another, and (ii) granting the individual sub-licenses to the respective terminal devices.

Patent Literature 2 discloses an authentication server that, by recording respective terminal ID's of terminal devices on each of which a content can be viewed, permits a user to view a content on a predetermined number of terminals. Patent Literature 3 discloses a business system that permits a plurality of persons to simultaneously log in to it on the basis of a single account.

Patent Literature 4 discloses an authentication server that permits a user to use in combination (i) authentication for a group and (ii) authentication for an individual. Patent Literature 5 discloses a calculator that automatically logs out a user who has logged in to it with a user ID, if the user logs in to another calculator with the same user ID.

### CITATION LIST

Patent Literature 1

Japanese Patent Application Publication, Tokukai, No. 2005-55957 A (Publication Date: Mar. 3, 2005)

Patent Literature 2

Japanese Patent Application Publication, Tokukai, No. 2003-85145 A (Publication Date: Mar. 20, 2003)

Patent Literature 3

Japanese Patent Application Publication, Tokukai, No. 2002-342284 A (Publication Date: Nov. 29, 2002)

Patent Literature 4

Japanese Patent Application Publication, Tokukai, No. 2003-178027 A (Publication Date: Jun. 27, 2003)

Patent Literature 5

Japanese Patent Application Publication, Tokukai, No. 2005-309590 A (Publication Date: Nov. 4, 2005)

### SUMMARY OF INVENTION

### Technical Problem

The technique disclosed in Patent Literature 5, however, fails to permit users to receive a service simultaneously on a plurality of terminals on the basis of a single license. The respective techniques disclosed in Patent Literatures 1 through 4, each of which permits users to obtain authentication on a plurality of terminals on the basis of a single license under a certain condition for use of a service, involve not a few disadvantages from the viewpoint of a service provider.

Specifically, a service provider may, for example, intend to (i) permit users, for their convenience, to view a pay content on a plurality of terminals on the basis of a single license, but to (ii) in the case where the users view a pay content simultaneously on a plurality of terminals, constantly limit such a pay content to an identical content. The respective techniques disclosed in Patent Literatures 1 through 4 problematically fail to achieve such a service provider's intention.

The present invention has been accomplished in view of the above problem. It is a main object of the present invention to provide an operation control device that can, without causing a loss in the benefit for a license provider, cause an operation based on a license to be carried out by a plurality of terminals on the basis of such a single license.

### Solution to Problem

In order to solve the above problem, an operation control device of the present invention is an operation control device for controlling a first terminal and a second terminal, separate from the first terminal, on a basis of a license permitting (i) the first terminal to carry out any operation within a prescribed range and (ii) the second terminal to carry out, among the any operation, any operation within a partial range included in the prescribed range, the operation control device including: detecting means for detecting that the first terminal has switched operations within the prescribed range, the operations being carried out under the license; and operation control means for, in accordance with a kind of the operation carried out after the switch having been detected by the detecting means, changing the partial range of the operation that the second terminal is permitted to carry out under the license.

According to the above arrangement, the operation control device, if it has detected that the first terminal, which is capable of carrying out any operation within a prescribed range on the basis of a license, has switched operations, changes, in accordance with the operation carried out after the above switch by the first terminal, the range of an operation that the second terminal is permitted to carry out under the same license. Thus, regardless of what operation within the prescribed range the first terminal carries out on the basis of the license, the operation that the second terminal is permitted to carry out under the same license is limited as compared to the operation of the first terminal. In other words, the operation control device, as compared to the case in which the second terminal operates under a license independent of a license under which the first terminal operates, constantly further limits the operation that the second terminal is permitted to carry out than the operation of the first terminal.

The operation control device can therefore, without causing a loss in the benefit for a license provider, cause an operation based on a license to be carried out by a plurality of terminals on the basis of such a single license.

In order to solve the above problem, an operation control method of the present invention is an operation control method carried out by an operation control device for controlling a first terminal and a second terminal, separate from the first terminal, on a basis of a license permitting (i) the first terminal to carry out any operation within a prescribed range and (ii) the second terminal to carry out, among the any operation, any operation within a partial range included in the prescribed range, the operation control method including: a detecting step for detecting that the first terminal has switched operations within the prescribed range, the operations being carried out under the license; and an operation control step for, in accordance with a kind of the operation carried out after the switch having been detected in the detecting step, changing the partial range of the operation that the second terminal is permitted to carry out under the license.

According to the above arrangement, the operation control method of the present invention achieves an advantage similar to that achieved by the operation control device of the present invention.

### Advantageous Effects of Invention

As described above, an operation control device of the present invention can, without causing a loss in the benefit for a license provider, cause an operation based on a license to be carried out by a plurality of terminals on the basis of such a single license.

### BRIEF DESCRIPTION OF DRAWINGS

FIG. 1

FIG. 1 is a block diagram illustrating respective main configurations of a user terminal, a license server, and a service provision server all included in a license provision system of Embodiment 1.

FIG. 2

FIG. 2 is a diagram concisely illustrating the configuration of the license provision system of Embodiment 1.

FIG. 3

FIG. 3 is a flowchart illustrating an operation by the license server for issuing a license.

FIG. 4

FIG. 4 is a flowchart illustrating an operation of a license synchronization processing by the license provision system.

FIG. 5

(a) through (f) are flowcharts illustrating respective operations of processes for controlling a license authorization.

FIG. 6

FIG. 6 is a diagram illustrating a structure of a license table indicative of (i) the use state for a license and (ii) whether a license is issuable.

FIG. 7

FIG. 7 is a table specifically illustrating, for each value in the license table, (i) the scope of right of a main license, (ii) that of right of a sub-license, and (iii) whether a license is issuable.

FIG. 8

FIG. 8 is a table specifically illustrating, for each value in the license table, (i) the scope of right of a main license, (ii) that of right of a sub-license, and (iii) whether a license is issuable.

FIG. 9

FIG. 9 is a table specifically illustrating, for each value in the license table, (i) the scope of right of a main license, (ii) that of right of a sub-license, and (iii) whether a license is issuable.

FIG. 10

FIG. 10 is a diagram showing specific values in a license table.

FIG. 11

FIG. 11 is a diagram showing specific values in a license table.

FIG. 12

FIG. 12 is a diagram showing specific values in a license table.

FIG. 13

FIG. 13 is a diagram showing specific values in a license table.

FIG. 14

FIG. 14 is a diagram showing specific values in a license table.

FIG. 15

FIG. 15 is a diagram showing specific values in a license table.

FIG. 16

FIG. 16 is a diagram showing specific values in a license table.

FIG. 17

FIG. 17 is a diagram showing specific values in a license table.

FIG. 18

FIG. 18 is a diagram showing specific values in a license table.

FIG. 19

FIG. 19 is a diagram showing specific values in a license table.

FIG. 20

FIG. 20 is a diagram showing specific values in a license table.

FIG. 21

FIG. 21 is a diagram showing specific values in a license table.

FIG. 22

FIG. 22 is a diagram showing specific values in a license table.

FIG. 23

FIG. 23 is a diagram showing specific values in a license table.

FIG. 24

FIG. 24 is a diagram showing specific values in a license table.

FIG. 25

FIG. 25 is a diagram illustrating a UI for allowing a user to select a service available.

FIG. 26

FIG. 26 is a diagram illustrating a UI for informing a user using a service on the basis of a sub-license that the use of the service is limited due to the presence of a user using a service on the basis of a main license.

FIG. 27

FIG. 27 is a diagram illustrating a UI for informing a user viewing a content on the basis of a sub-license that the viewing of the content is limited due to the presence of a user viewing a content on the basis of a main license.

FIG. 28

FIG. 28 is a diagram illustrating a UI that is displayed in the case where a request made to use a service by a user on the basis of a sub-license is rejected.

FIG. 29

FIG. 29 is a diagram illustrating a UI for allowing a user to select a viewable program content.

FIG. 30

FIG. 30 is a diagram illustrating a UI for informing a user that a content will be viewed in a synchronization mode.

FIG. 31

FIG. 31 is a diagram illustrating a UI for selecting a user to synchronize with in the case where a content will be viewed in a synchronization mode.

FIG. 32

FIG. 32 is a diagram illustrating a UI for notifying a user that another user has synchronized with them in a synchronization mode.

FIG. 33

FIG. 33 is a diagram illustrating a UI for notifying, in the case where a content being viewed on the basis of a main license has been switched, a user currently viewing a content on the basis of a sub-license that the user is not permitted to continue viewing the current content.

FIG. 34

FIG. 34 is a diagram illustrating a UI for notifying, in the case where a content being viewed on the basis of a main license has been switched, a user currently viewing a content on the basis of a sub-license that the user will be prevented from viewing the current content after a certain period of time.

FIG. 35

FIG. 35 is a part of a sequence diagram illustrating an example operation of controlling the issue of a main license.

FIG. 36

FIG. 36 is a part of a sequence diagram illustrating an example operation of controlling the issue of a main license, the part showing a continuation of the operation illustrated in FIG. 35.

FIG. 37

FIG. 37 is a part of a sequence diagram illustrating an example operation of controlling the issue of a main license, the part showing a continuation of the operation illustrated in FIG. 36.

FIG. 38

FIG. 38 is a block diagram illustrating respective main configurations of a main terminal, a sub-terminal, a license server, and a service provision server all included in a license provision system of Embodiment 2.

FIG. 39

FIG. 39 is a part of a sequence diagram illustrating an operation of controlling the issue of a sub-license.

FIG. 40

FIG. 40 is a part of a sequence diagram illustrating an example operation of controlling the issue of a sub-license, the part showing a continuation of the operation illustrated in FIG. 39.

FIG. 41

FIG. 41 is a part of a sequence diagram illustrating an example operation of controlling the issue of a sub-license, the part showing a continuation of the operation illustrated in FIG. 40.

FIG. 42

FIG. 42 is a part of a sequence diagram illustrating an example of a main-license content switch following operation.

FIG. 43

FIG. 43 is a part of a sequence diagram illustrating an example of a main-license content switch following operation, the part showing a continuation of the operation illustrated in FIG. 42.

### DESCRIPTION OF EMBODIMENTS

### Embodiment 1

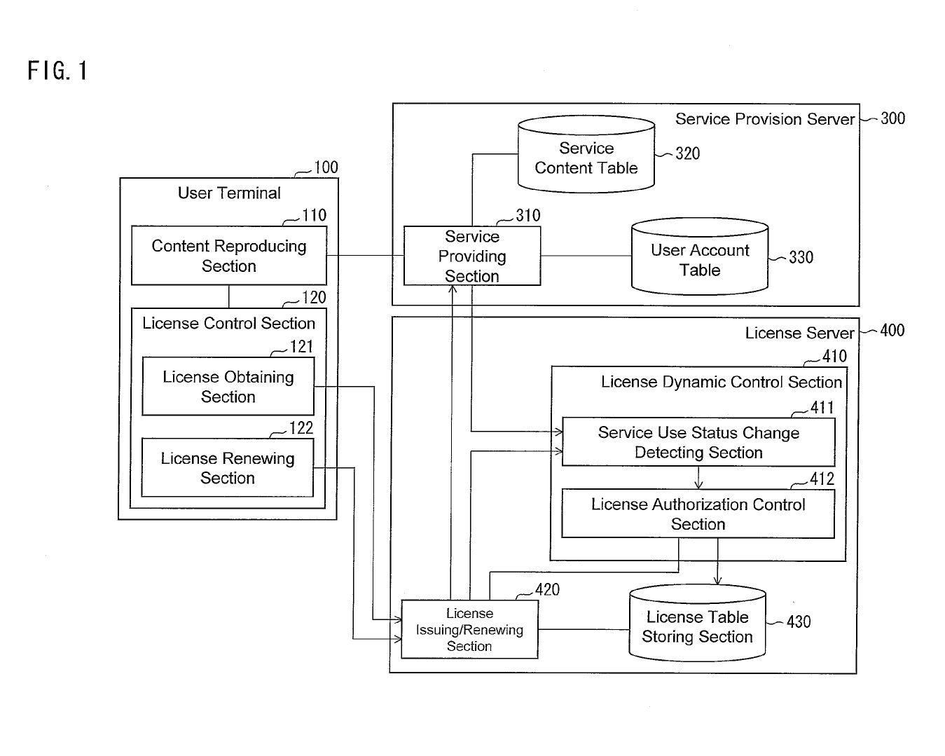

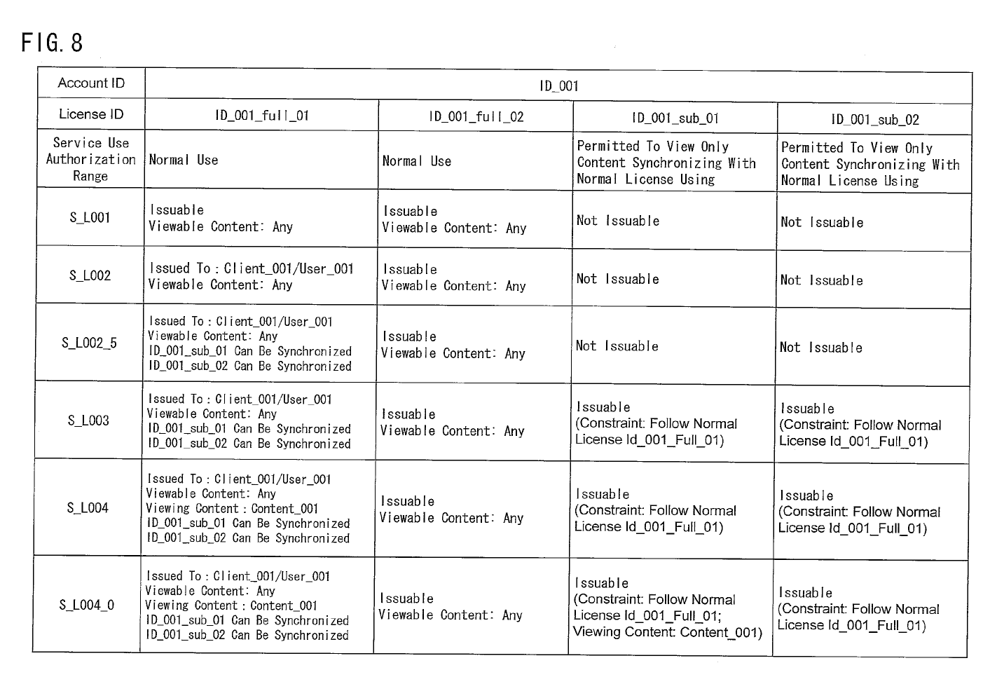

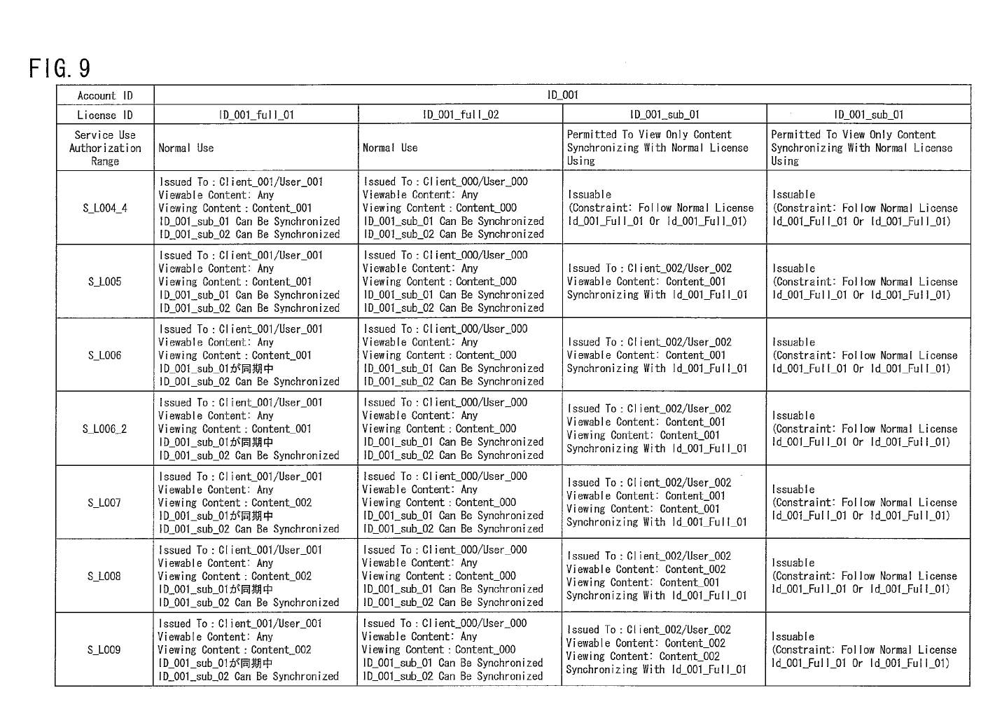

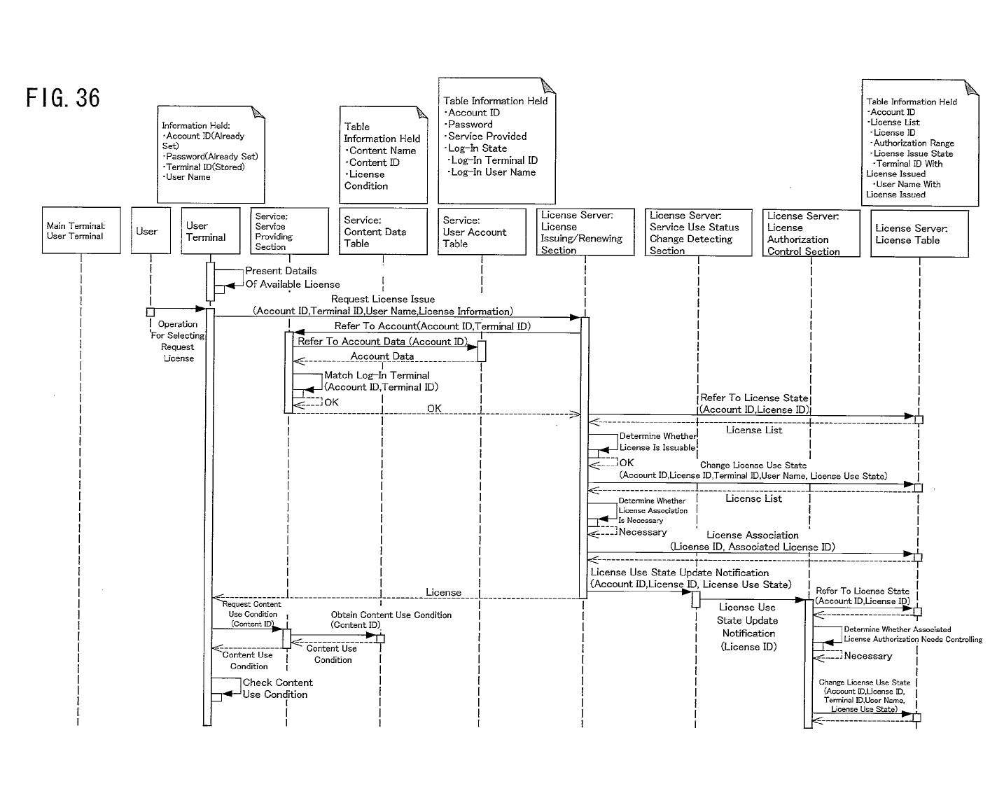

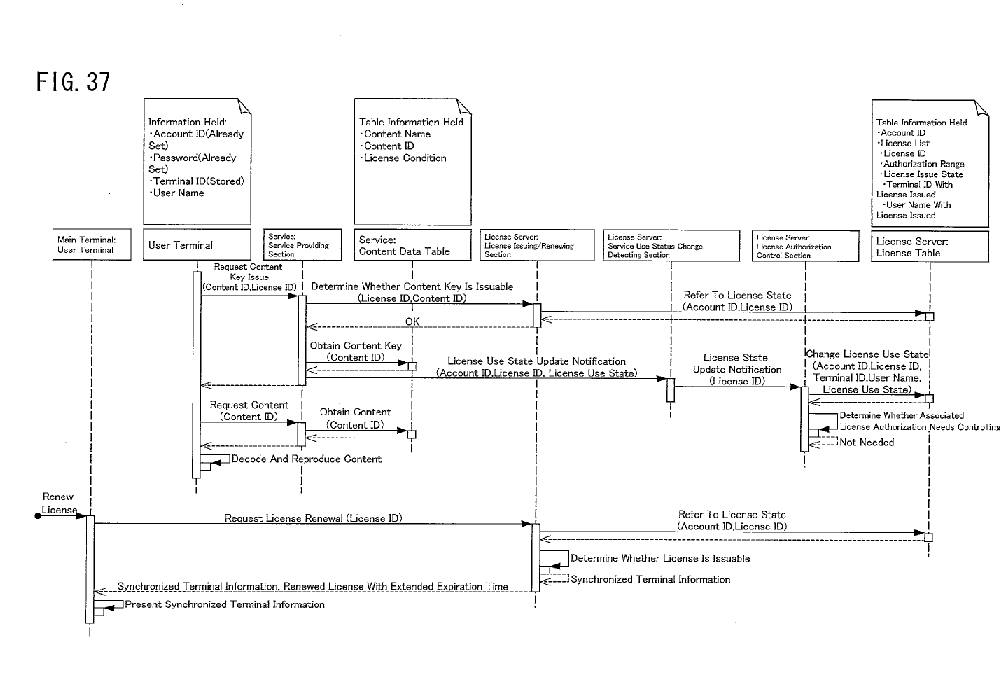

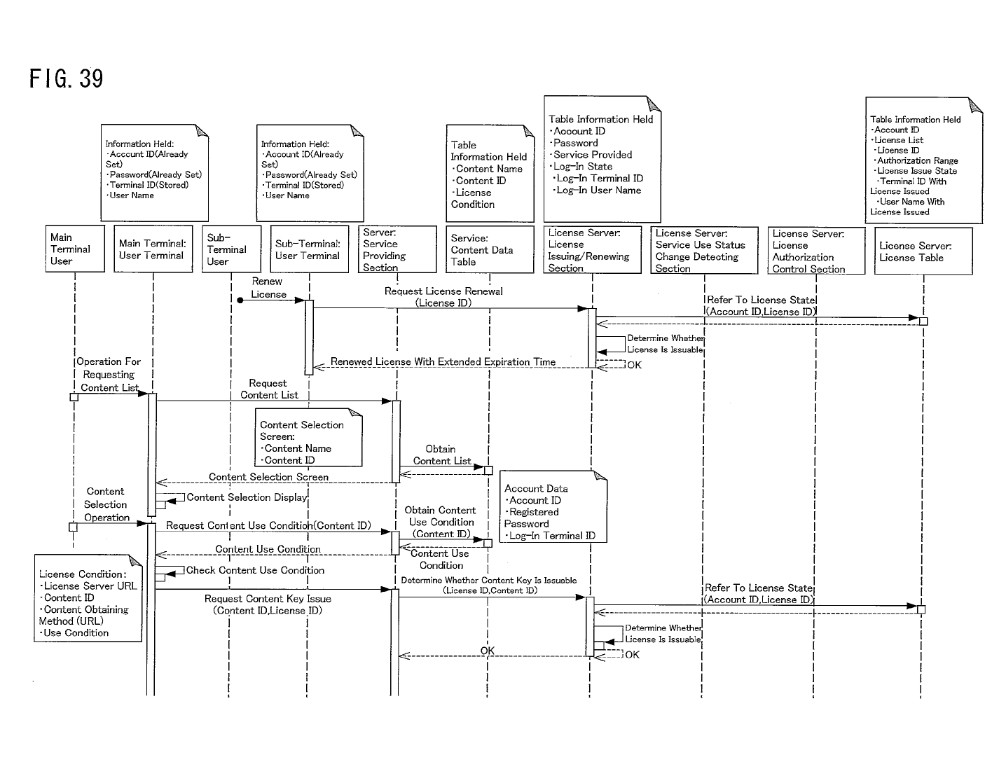

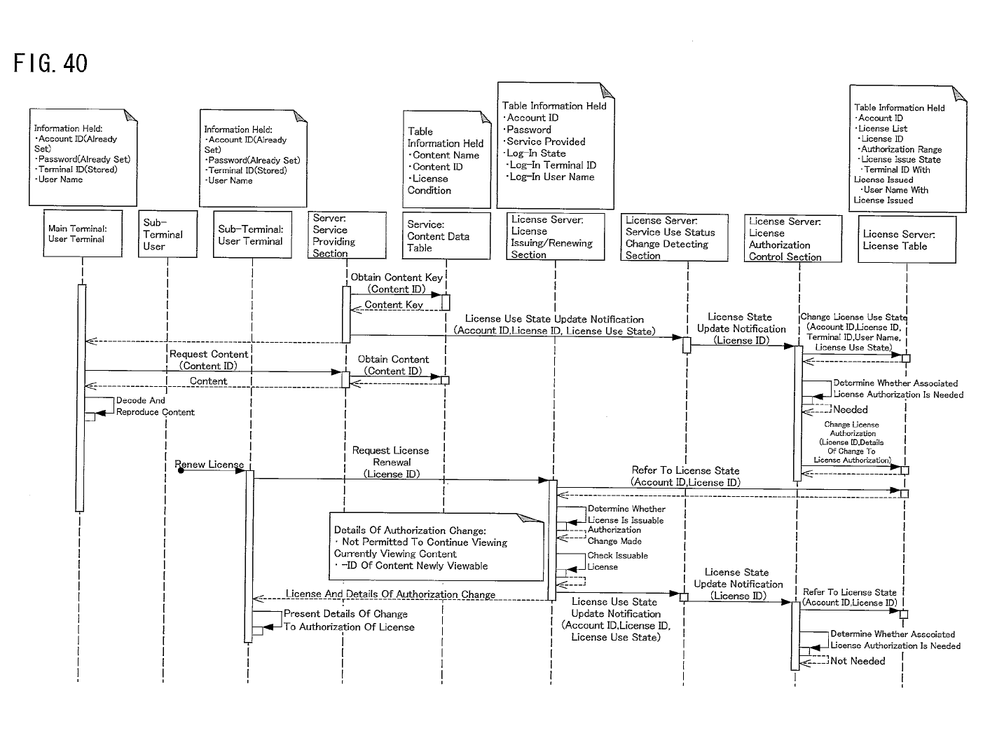

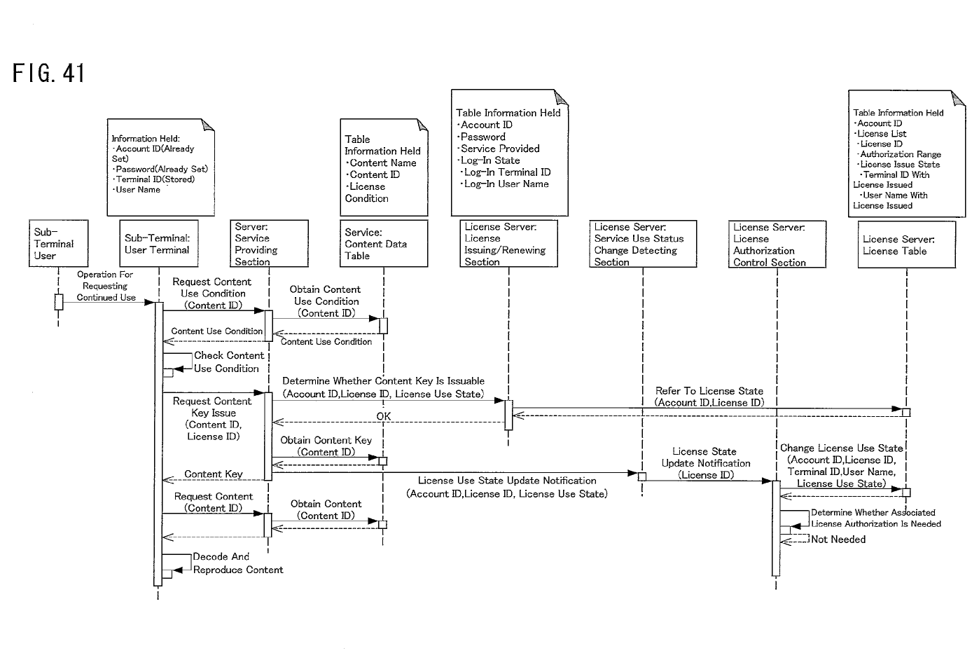

With reference to FIGS. 1 through 37 and 39 through 43, the description below deals, in accordance with an embodiment of the present invention, with a license provision system including (i) a license server, (ii) a service provision server, and (iii) user terminals, all communicably connected to one another.

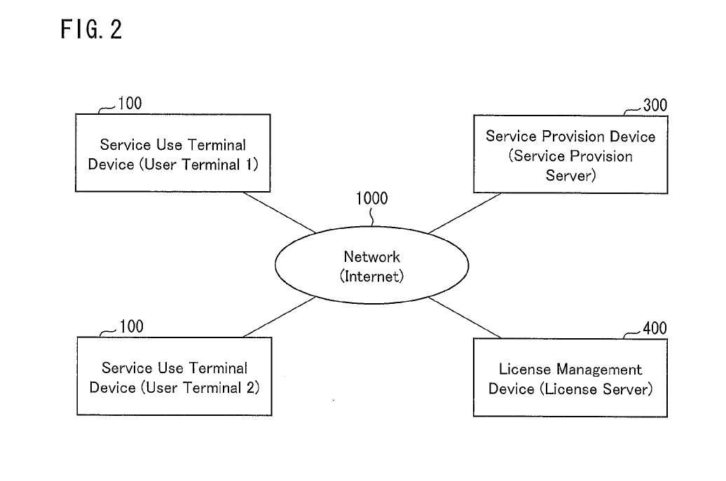

FIG. 2 concisely illustrates a configuration of the license provision system. The license provision system, as illustrated in FIG. 2, includes: service use terminal devices (user terminals) 100; a service provision server 300; and a license server 400, all of which are communicably connected to one another over a network 1000.

The service provision server 300 carries out such processes as (i) authentication of a user intending to use a service, (ii) presentation, to a user terminal 100, of a screen allowing selection of a content to be reproduced, and (iii) distribution of a content to the user terminals 100. In the description herein, using a service refers to, for example, viewing a content.

The user terminals 100 each request the service provision server 300 to distribute a content, and thus reproduce a distributed content. A user terminal 100, if holding no license to reproduce a content, requests the license server 400 to issue such a license to the user terminal 100.

The license server 400 is a server that issues a main license and a sub-license to a user terminal 100. A sub-license is a license that accompanies a main license. A main license and a sub-license are included in a single license that is granted to a user on the basis of a single use agreement. A sub-license is limited in scope of right as compared to a main license. Further, a sub-license has its expiration time set thereto. A user terminal 100 holding a sub-license issued thereto requests, when the sub-license has reached its expiration time, the license server 400 to renew the sub-license. The license server 400, in response to such a request, controls the operation of the user terminal 100 in accordance with a change to the authorization available on the basis of the sub-license. The license server, for instance, (i) checks whether there has been made any change to the authorization and (ii) if there has been made any change to the authorization, notifies the user terminal 100 of such a change. Note that the description below of the present specification uses the term “license” to refer to either “main license” or “sub-license” unless otherwise stated.

The following describes, with reference to FIG. 1, respective arrangements of a user terminal 100, the service provision server 300, and the license server 400. FIG. 1 is a block diagram illustrating respective main configurations of a user terminal 100, the service provision server 300, and the license server 400.

<Arrangement of User Terminal 100>

A user terminal 100 includes a content reproducing section 110 and a license control section 120. The content reproducing section 110 obtains a content from the service provision server 300 and reproduces the content. The content reproducing section 110 is capable of normal reproduction and trick reproduction of a content.

The license control section 120 includes a license obtaining section 121 and a license renewing section 122. The license obtaining section 121 requests the license server 400 to issue a license to the user terminal 100 and thus obtains a license. The license renewing section 122 requests the license server 400 to renew a license.

<Arrangement of Service Provision Server 300>

The service provision server 300 includes a service providing section 310, a service content table 320, and a user account table 330.

The service providing section 310, for instance, presents available contents in response to a request by the user terminal 100, and transmits to the user terminal 100 a content required by the user terminal 100.

The service content table 320 includes, recorded therein, (i) metadata on a content which metadata is, for example, a condition of content use in accordance with an agreement and (ii) content data. The service content table 320 further includes, recorded therein, a decoding key for decoding content data, which is recorded in a state where it is encrypted.

The user account table 330 includes, recorded therein, such information as account information for a user, information indicative of a log-in state for a user, and information on a service that can be provided.

<Arrangement of License Server 400>

The license server 400 includes a license dynamic control section 410, a license issuing/renewing section 420, and a license table storing section 430.

The license dynamic control section 410 includes a service use status change detecting section 411 and a license authorization control section 412. The service use status change detecting section 411 detects a change to (i) the state of issue of a license to the user terminal 100 and (ii) the state of use of a service by the user terminal 100, and thus notifies the license authorization control section 412 of such a change. The license authorization control section 412 updates a value in a license table to control the scope of right of a license.

The license issuing/renewing section 420, for instance, issues a license to the user terminal 100 in response to a request by the user terminal 100, and renews a license recorded in the user terminal.

The license table storing section 430 includes, recorded therein, a license table indicating, for each user account, (i) the scope of right of a license and (ii) a terminal to which the license has been issued.

The following description first details the license table to which the license server refers in issuing a license, and then deals with the operation of the license server 400.

(License Table in Detail)

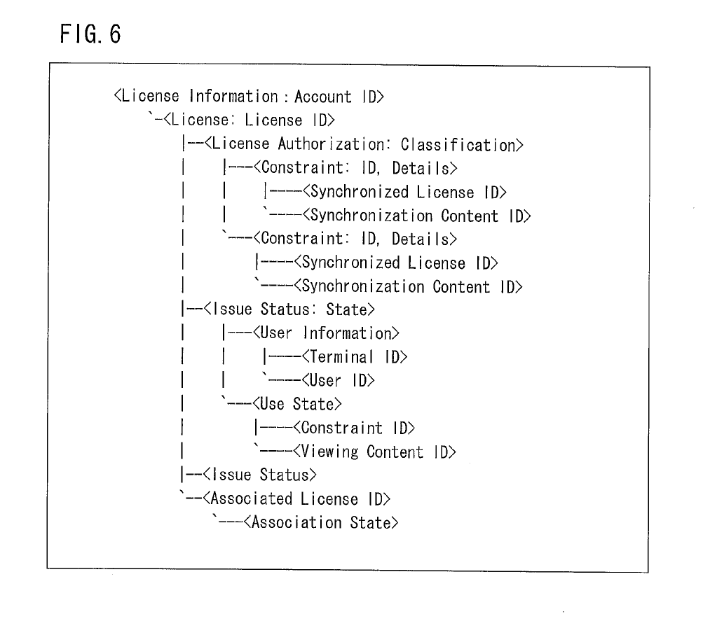

The following first describes a table structure of the license table with reference to FIG. 6. FIG. 6 is a diagram showing a table structure of the license table.

The license table is present for each account as is clear from FIG. 6, which shows “account ID” in the uppermost class of the table.

The item “account ID” is immediately followed by a lower class including “license ID”, which is an ID that identifies one or more licenses issued to a terminal. The item “license ID” is immediately followed by a lower class including “license authorization classification”, “issue status”, and “associated license ID”.

The item “license authorization classification” contains one of the two values “full” and “sync”. The two values indicate whether a license (hereinafter referred to as “target license”) indicated by “license ID” in the upper class is a main license or a sub-license.

The item “license authorization classification” is, in the case where it contains the value “sync”, immediately followed by a lower class including one or more “constraint ID” items recorded in the table. Each constraint ID is immediately followed by a lower class including “synchronization target license ID” and “synchronization content ID” recorded in the table. The item “synchronization target license ID” indicates that a terminal operating on the basis of a target license is permitted to reproduce a content being reproduced by a terminal on the basis of a main license indicated by the ID. The item “synchronized content ID” is an ID indicative of a content that the terminal operating on the basis of the target license is permitted to reproduce. The term “synchronization” refers t o a terminal actually reproducing a content on the basis of a sub-license which content is being reproduced by another terminal on the basis of a main license.

The item “issue status” indicates whether a target license has been “already issued” or is “issuable”. The item “issue status” is, in the case where it is indicative of “already issued”, immediately followed by a lower class that includes, recorded in the table: as “user information”, (i) “terminal ID” indicative of a terminal to which the license has been issued and (ii) “user ID” indicative of a user using the license; and, as “use state”, “constraint ID” indicative of a constraint imposed under the target license.

The item “associated license ID” is, in the case where the target license is a main license, (i) indicative of the license ID of a sub-license and (ii) recorded when the main license is issued. The item “associated license ID” is, in the case where the target license is a sub-license, (i) indicative of the license ID of an already issued main license and (ii) also recorded when the main license is issued. In the case where the target license is a sub-license, “associated license ID” is immediately followed by a lower class including, recorded in the table, synchronization state. Similarly, in the case where the target license is a main license, “associated license ID” is immediately followed by a lower class including, recorded in the table, “association state” indicative of “being synchronized” while in a synchronization state.

(Operation of License System)

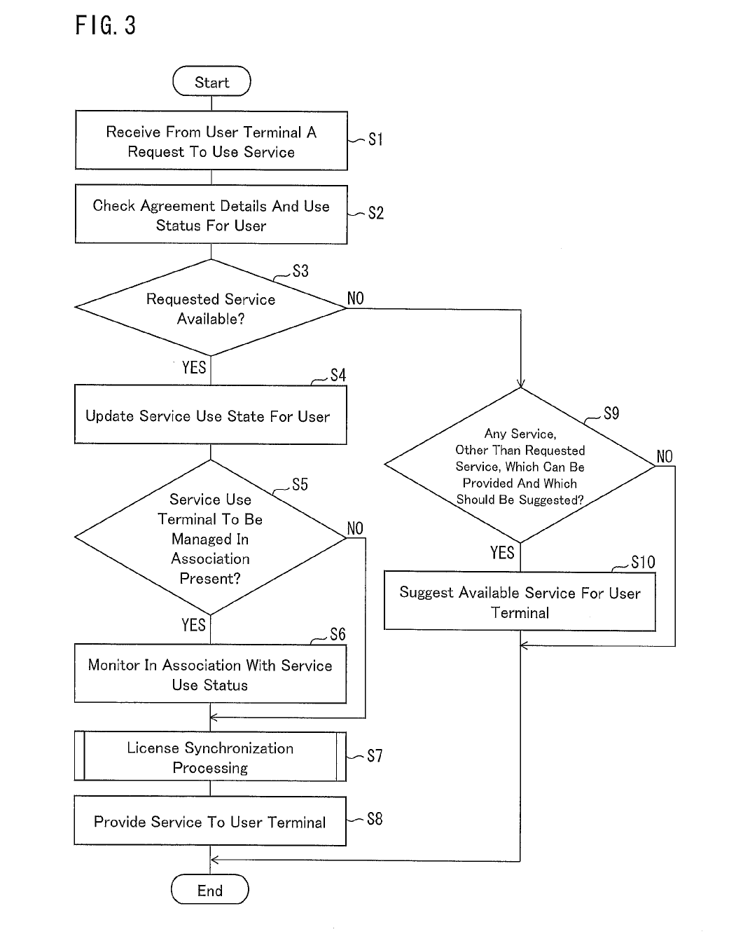

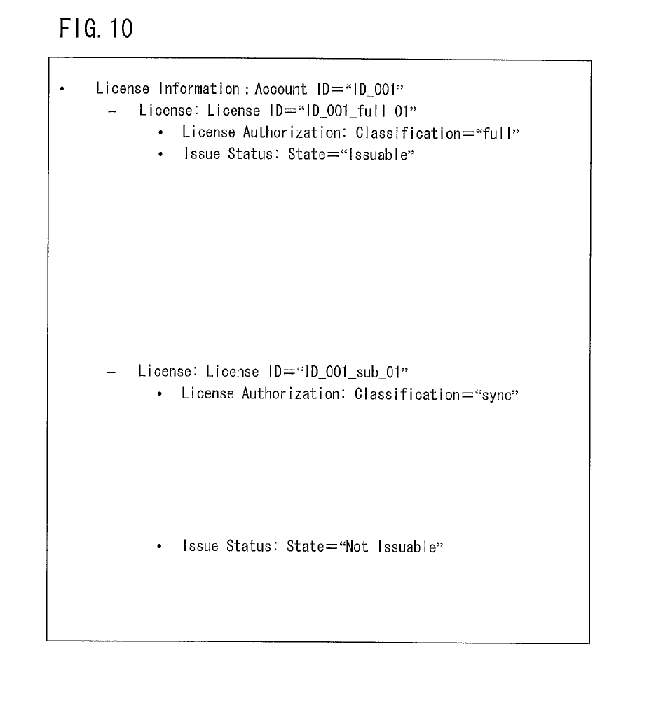

The following describes, with reference to FIGS. 3, 10-15, 25-31, 33, and 34, an operation carried out, in the license provision system, from (i) the time at which a user terminal 100 requests a service from the service provision server 300 to (ii) the time at which the user terminal 100 starts using the service. In particular, the description below details, with reference to FIG. 3, a main-license issuing operation carried out during the above operation. The description below deals with the operation of the license system on the basis of an example in which a user intending to use a service has an account (account ID: “ID_001”) that permits a user terminal 100 to have, issued thereto, two main licenses (license ID's: “ID_001_full_01” and “ID_001_full_02”) and two sub-licenses (license ID's: “ID_001_sub_01” and “ID_001_sub_02”). The description below assumes that the user terminal 100 requests a service from the service provision server 300 with reference to a license table including values as shown in the license table S_L001 of FIG. 10.

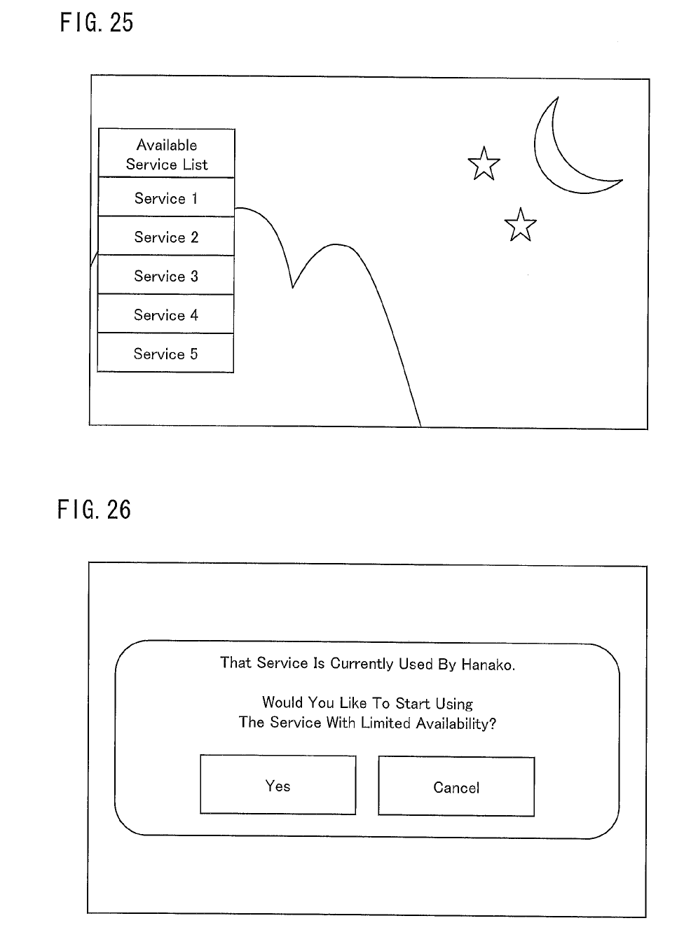

FIG. 3 is a flowchart showing an operation of the license server 400 for issuing a license to a user terminal 100. FIGS. 10 through 15 are diagrams showing specific values of license tables for the account ID “ID_001” in some of the steps in the flowchart. FIGS. 25-31, 33, and 34 are diagrams illustrating UI's (user interfaces) displayed by the user terminal 100 in some of the steps in the flowchart. The respective license tables in FIGS. 10 through 15 each omit all the classes for “license ID” of “ID_001_full_02” and all the classes for “license ID” of “ID_001_sub_02”.

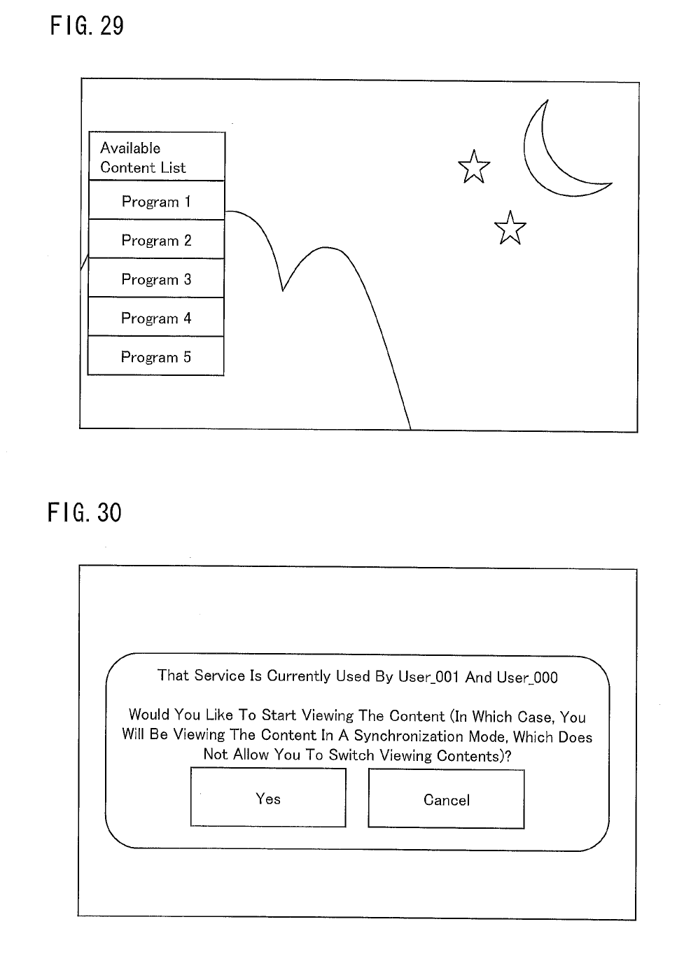

First, the user terminal 100 transmits a log-in request to the service provision server 300. The service providing section 310 of the service provision server 300, in response, carries out an authentication with reference to the user account table 330. If the service providing section has successfully carried out an authentication, the service providing section, in return, notifies the user terminal 100 of the success in the authentication, and transmits to the user terminal a list of contents stored in the service content table 320. The user terminal 100, in response, causes a display section (not shown) to display a UI such as the UI illustrated in FIG. 29.

If the user has selected a content (for example, “PROGRAM 1” in FIG. 29), the user terminal 100 transmits an inquiry to the service provision server 300 about a content use condition for the selected content. The service providing section 310 of the service provision server 300, in response, refers to the service content table 320 to transmit, back to the user terminal, content use condition information indicative of the content use condition.

The content use condition information includes (i) content information such as a content ID and a content obtaining target URL and (ii) information on, for example, a license server URL, a viewing permission expiration, and a copying permission count. In the present embodiment, the content ID is set to the value “Content_001” indicative of “PROGRAM 1”.

When the user terminal 100 has received the content use condition information, the license obtaining section 121 of the user terminal requests a license server 400, specified by the license server URL, to issue a main license to the user terminal 100.

(Main License Issuing Operation of License Server 400)

The description below refers to FIG. 3. First, the license issuing/renewing section 420 of the license server 400 receives, from the license obtaining section 121 of the user terminal 100, a request to use a license (S1). The license use request includes a user name, an account ID, a content ID, and a terminal ID all inputted by the user. The license issuing/renewing section 420, upon receipt of such a use request, transmits an inquiry to the service providing section 310 about whether the use request is valid. More specifically, the license issuing/renewing section inquires about whether (i) the account ID included in the license use request is registered in the user account table 330 and (ii) the account ID and the terminal ID both included in the license use request respectively match the account ID and the terminal ID both included in the log-in request transmitted to the service provision server 300. The license issuing/renewing section 420, upon receipt of a notification from the service providing section 310 to the effect that the use request is valid, refers to the license table storing section 430 to refer to (i) the scope of right of a main license recorded in a license table for the account indicated by the account ID and (ii) the state (that is, whether the main license has been issued to any terminal) of issue of the main license (S2). The license issuing/renewing section 420 thus determines whether the main license requested is available (S3). Specifically, in the case where the license table includes, recorded therein, any main license with an “issue status” of “issuable”, the license issuing/renewing section determines that the main license is available. For instance, in the case where the license table includes values as shown in S_L001 of FIG. 10, the main license with the license ID “ID_001_full_01” (hereinafter referred to simply as main license “ID_001_full_01”) is issuable.

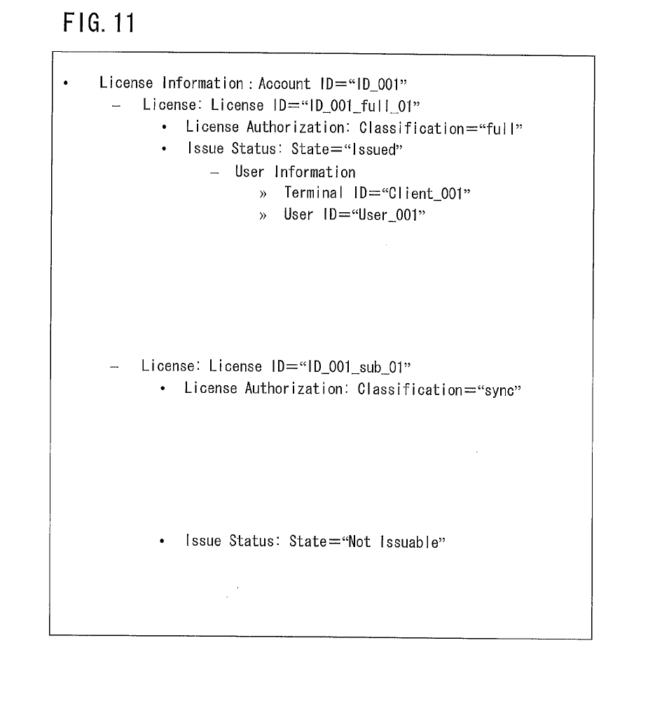

If the license issuing/renewing section has determined that a main license is available (YES in S3), the license authorization control section 412 updates a license use state recorded in the license table (S4). Specifically, the license authorization control section 412 sets the “issue status” for the “license ID” of the main license to be issued to “already issued”, and records the “terminal ID” and “user ID” as “user information”. The update of the license use state changes the values of the license table from the state of the license table S_LO01 to the state of the license table S_L002 shown in FIG. 11.

The license issuing/renewing section 420 then determines whether there is any sub-license to be managed in association with the main license to be issued (S5). A sub-license to be managed in association with a main license refers specifically to a sub-license with a “license ID” that is not recorded in the item “associated license ID” in a class lower than the class of the “license ID” of the main license.

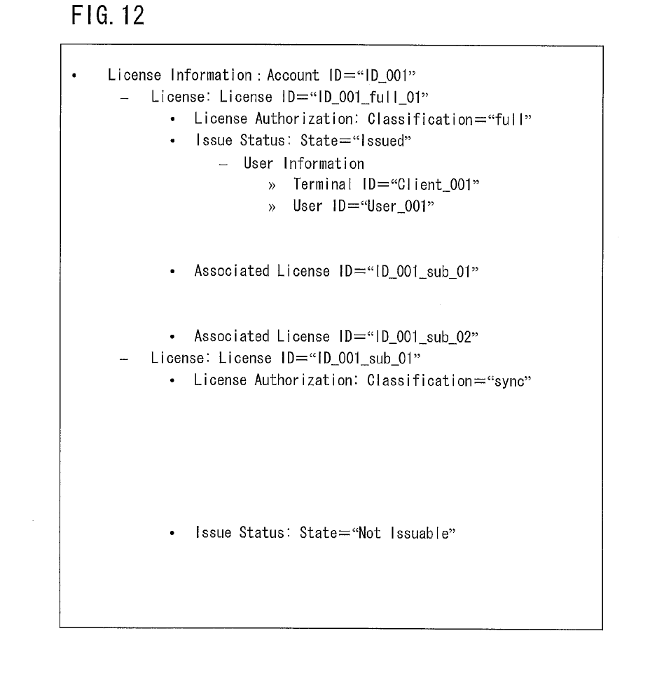

If the license issuing/renewing section has determined that there is a sub-license to be managed in association (YES in S5), the license issuing/renewing section 420 associates (i) the main license to be issued with (ii) the sub-license to be managed in association therewith (S6). The process then proceeds to S7. The above association changes the values of the license table to the values of the license table S_L002_5 shown in FIG. 12. If the license issuing/renewing section has determined that there is no sub-license to be managed in association (NO in S5), the process directly proceeds to S7.

The license authorization control section 412 next starts a license synchronization processing (S7), and then issues the main license to the user terminal 100. The operation during the license synchronization processing is described later in detail.

The user terminal 100 (hereinafter referred to also as “main terminal 100”) that has received the main license transmits, to the service provision server 300, a request for a service. The service providing section 310, upon receipt of the request, transmits an inquiry to the license server 400 about whether the user terminal 100 has the authorization to use the service. If the license server has, in response, informed the service provision server that the user terminal has the authorization, the service provision server provides the service to the user terminal 100 (S8), and ends the process. The following describes the step S8 in detail.

The content reproducing section 110 transmits to the service provision server 300 (i) the content ID “Content_001” included in the content use condition information and (ii) the license ID (“ID_001_full_01”) in order to request the service provision server to issue a decoding key necessary to decode the “PROGRAM 1”.

When the service provision server 300 has accepted the request to issue a decoding key, the service providing section 310 retrieves the account ID of a user of the main terminal 100 from the user account table 330. The service providing section then transmits to the license server 400 (i) the account ID (“ID_001”), (ii) the license ID (“ID_001_full_01”), and (iii) the content ID “Content_001” to inquire about whether to issue the decoding key. The license server 400, upon receipt of the inquiry, refers to the license table for the account ID (“ID_001”) received. In this example, the license table includes values as shown in the license table S_L002_5. In the license table, the license ID (“ID_001_full_01”) indicates “full” for the classification of license authorization. The license server 400 thus determines that the decoding key is issuable, and notifies the service provision server 300 to that effect.

When the service provision server 300 has received the notification to the effect that the decoding key is issuable, the service providing section 310 reads from the content table 320 the decoding key for decoding the content data of the program 1, and transmits the decoding key to the main terminal 100. The service providing section further notifies the service use status change detecting section 411 in the license server 400 that the main terminal 100 has started reproduction of the program 1. When the main terminal 100 has received the decoding key, the content reproducing section 110 (i) accesses the content obtaining target URL included in the content use condition information received in advance, (ii) obtains encrypted content data of the program 1, and (iii) decodes the content data with use of the decoding key for reproduction of the program 1.

If the license issuing/renewing section has determined that a main license is unavailable (NO in S3), the license issuing/renewing section determines whether there is any service, other than the requested service, which should be suggested and for which a sub-license is issuable (S9).

If the license issuing/renewing section has determined that there is such a service to be suggested (YES in S9), the license issuing/renewing section causes the display section (not shown) of the user terminal 100 to display information on that service (S10), and ends the process. If the license issuing/renewing section has determined that there is no such service to be suggested (NO in S9), the license issuing/renewing section causes the user terminal 100 to display an UI such as that in FIG. 28, and ends the license issuing process.

The above service to be suggested is, for example, a service that shares a common attribute with a service requested. For instance, in the case where a service requested is a service of viewing a news content A for which service a sub-license is not issuable, a service to be suggested is a service of viewing a news content B (that shares the same genre with the service requested) for which service a sub-license is issuable. Such a service is suggested through a UI such as that in FIG. 25.

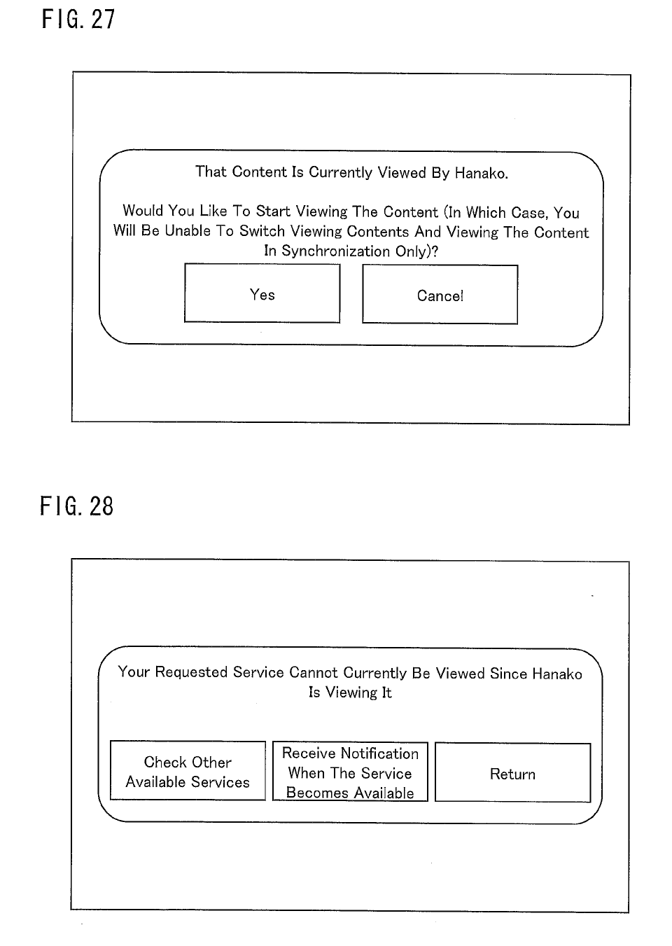

Alternatively, in the case where (i) a main license for a requested service is not issuable, but (ii) a sub-license for a partially limited service is issuable, the license issuing/renewing section may suggest such a service executable on the basis of the sub-license. For instance, in the case where a service requested is already being used by a person named Hanako at another terminal on the basis of a main license, the license issuing/renewing section 420 suggests a service that corresponds to the requested service with a partial limit. Such a service is suggested through a UI such as that in FIG. 26. As a more specific example, in the case where (i) a service requested is of viewing any content and (ii) Hanako is already viewing a content A at another terminal on the basis of a main license, the license issuing/renewing section suggests a service that permits only viewing of the content A. Such a service is suggested through a UI such as those in FIGS. 27 and 30.

If the user has selected “Yes” in a UI such as those in FIGS. 26, 27, and 30, the user terminal 100 requests the license server 400 to issue to the user terminal 100 a sub-license for a limited service or viewing of a content A.

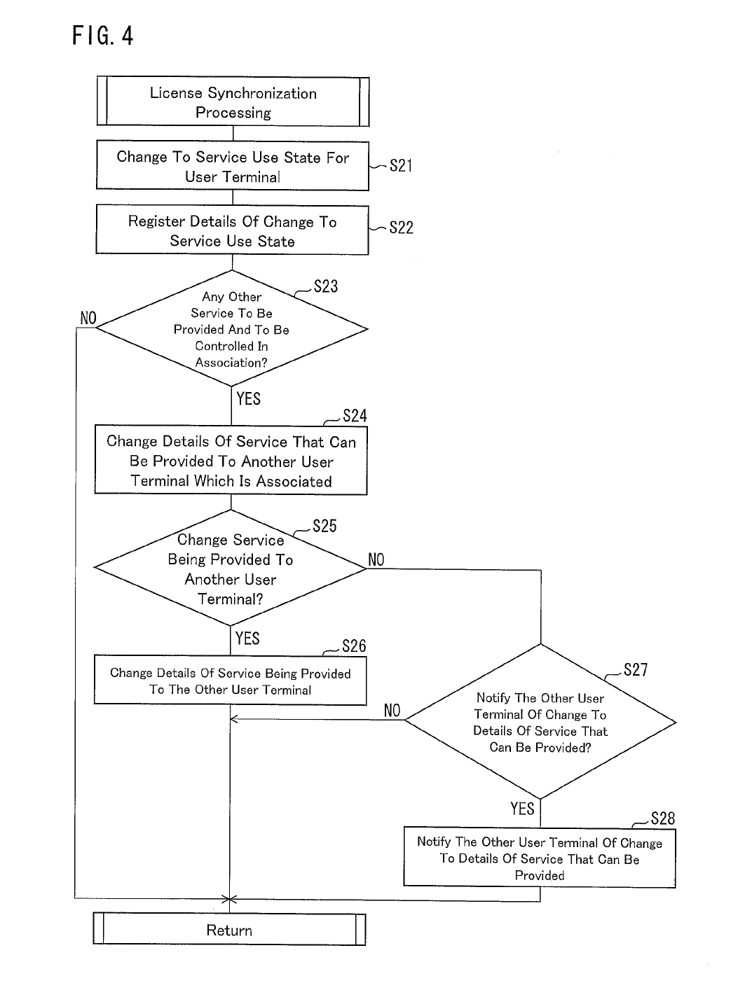

The following describes, with reference to FIG. 4, the license synchronization processing included in the above-described series of steps for issuing a main license.

FIG. 4 is a flowchart illustrating a flow of the license synchronization operation by the license server 400.

The license issuing/renewing section 420 notifies the service use status change detecting section 411 that the use state of the main license has been changed. The service use status change detecting section 411, in response, notifies the license authorization control section 412 that (i) the use state of the main license has been changed and that (ii) the main terminal 100 has started reproduction of the program 1 (S21).

The license authorization control section 412, upon receipt of the notification that the main terminal 100 has started reproduction of the program 1, registers details of the change to the service use state. Specifically, the license authorization control section updates the license table by changing the “issue status” of the “license ID” (“ID_001_full_01”) of the issued main license so that the “viewing content ID” is set to the value “Content_001” (S22).

The license authorization control section 412 then checks whether the license ID “ID_001_full_01” in the license table is immediately followed by a lower class including an “associated license ID”, and consequently checks whether there is any associated license associated with the main license issued to the user terminal 100 (S23). If the license authorization control section has determined that there is no associated license (NO in S23), the license authorization control section ends the processing. If the license authorization control section has determined that there is an associated license (YES in S23), the processing proceeds to the step S24 and its subsequent steps.

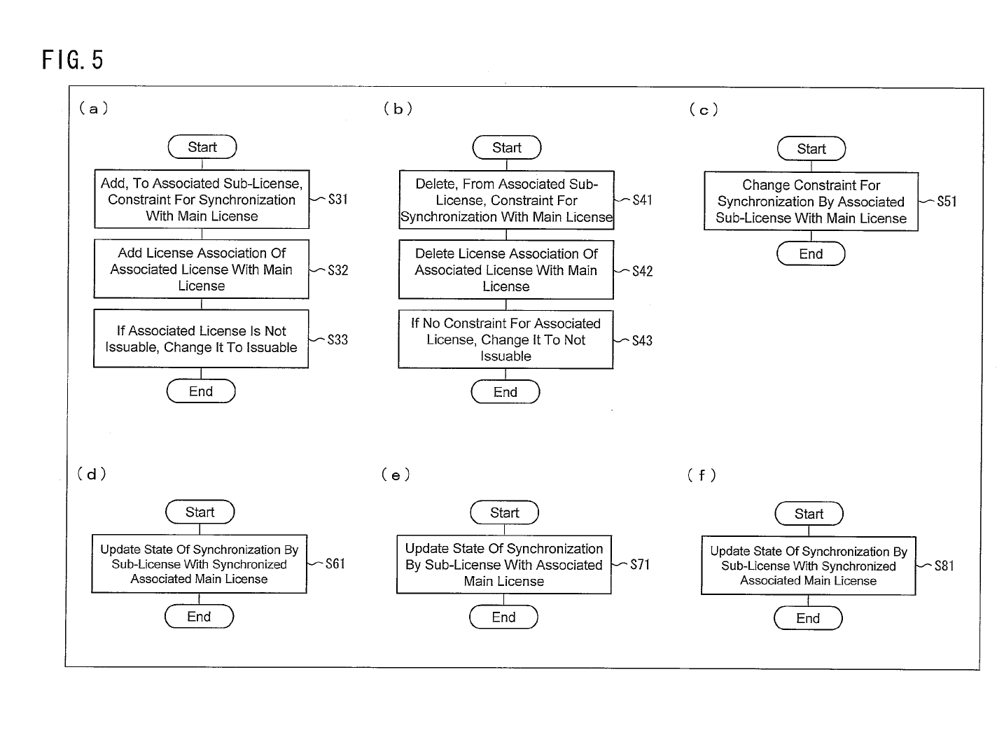

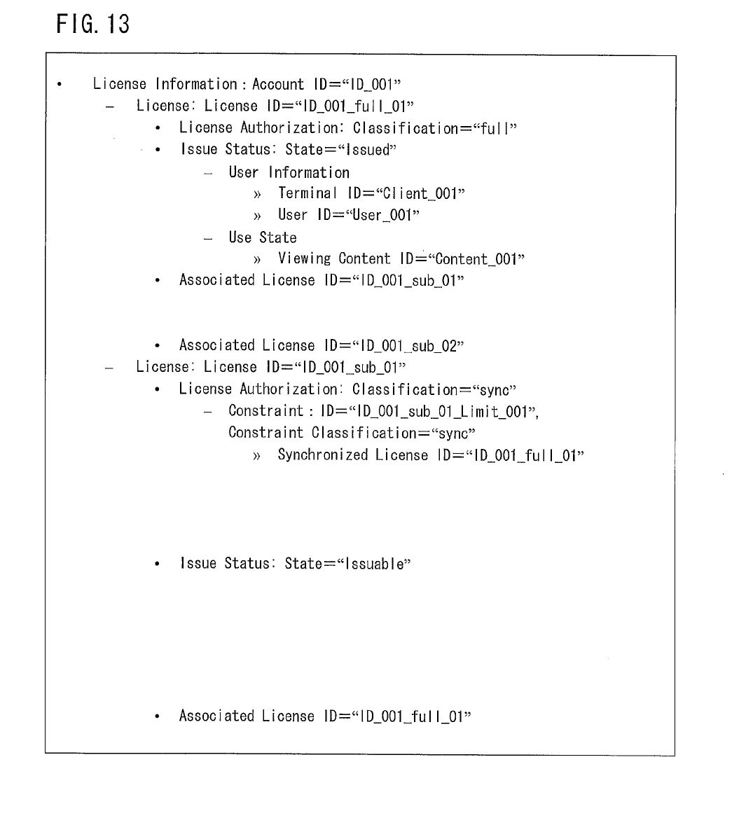

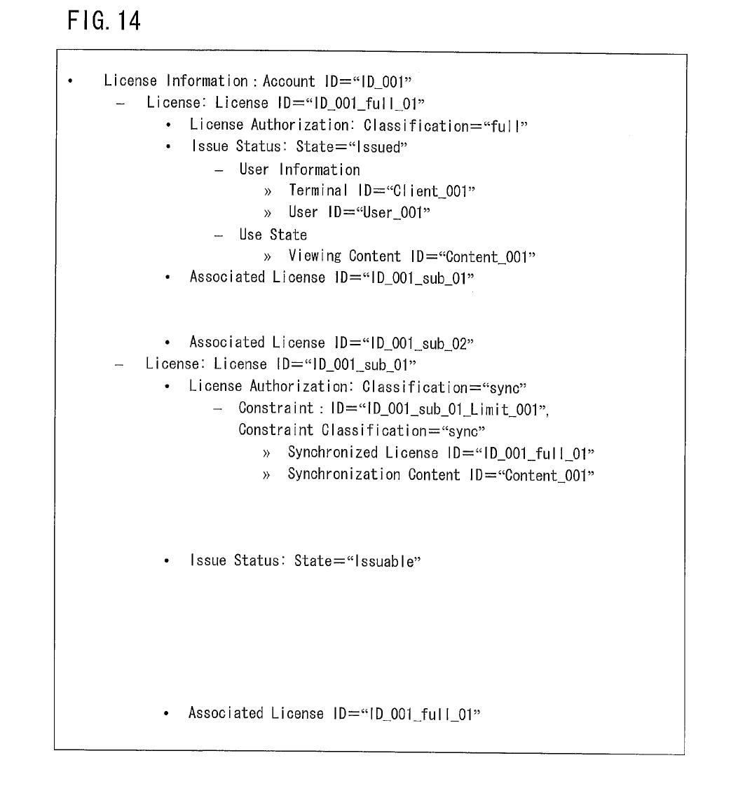

The license authorization control section 412 in S24 changes the details of a service being provided to another user terminal associated with the above user terminal. Specifically, the license authorization control section carries out an operation specified in S31 through S33 in (a) of FIG. 5 and S51 in (c) of FIG. 5. More specifically, the license authorization control section adds, as a constraint on the associated license (sub-license), a “constraint” for the item “synchronized license ID” to be the value “ID_001_full_01” (S31). The license authorization control section then adds, as a sub-license, an “associated license” having the value “ID_001_full_01” (S32). The license authorization control section further sets the “issue status” of the sub-license to “issuable” (S33). This updates the values of the license table to the values of the license table S_L004 in FIG. 13. The license authorization control section next carries out an operation of S51 in (c) of FIG. 5 to update the values of the license table to the values of the license table S_L004_0 in FIG. 14. Specifically, the license authorization control section 412 records, for the associated licenses (license ID's: ID_001_sub_01 and ID_001_sub_02) associated with the issued main license (license ID: ID_001_full_01), (i) a “synchronized license ID” having the value “ID_001_full_01” and (ii) a “synchronized content ID” having the value “Content_01” both as constraints.

The license authorization control section 412, after the step S24, determines whether to change a service being provided to another user terminal to which the sub-license has been issued (S25). Specifically, the license authorization control section refers to the license table to determine whether there is a sub-license having (i) an “associated license ID” of “ID_001_full_01” and (ii) an “association state” of “synchronizing”.

If, for instance, the license authorization control section has determined that there is such a sub-license (YES in S25), the license authorization control section 412 notifies the license issuing/renewing section 420 to that effect, in response to which the license issuing/renewing section 420 changes the details of the service being provided to the other user terminal (S26). Specifically, the license issuing/renewing section 420, with reference to the license table, transmits the value “Content_001” for the “synchronized content ID” to the user terminal to which a sub-license having an “association state” of “synchronizing” has been issued.

If, for instance, the license authorization control section has determined that there is no such sub-license as in the case of the license table having the values shown in S_L004_0 (NO in S25), the processing proceeds to the step S27. The license authorization control section 412 determines whether to notify the other user terminal, to which a sub-license has been issued, that a service that can be provided has been changed (S27). Specifically, the license issuing/renewing section 420, with reference to the license table, determines whether there is a “license ID” having an “issue status” of “already issued”.

If the license issuing/renewing section has determined that there is no such license ID as in the case of the license table having the values shown in S_L004_0 (NO in S27), the license issuing/renewing section ends the processing.

If the license issuing/renewing section has determined that there is such a license ID (YES in S27), the processing proceeds to the step S28.

The license authorization control section 412 in S28 notifies the license issuing/renewing section 420 to that effect. The license issuing/renewing section 420, in response, notifies the other user terminal, to which the sub-license has been issued, that a service that can be provided has been changed. Specifically, the license issuing/renewing section 420 retrieves from the license table a “license ID” having an “issue status” of “already issued”. The license issuing/renewing section then transmits, (i) for each “license ID” retrieved and (ii) to a user terminal to which a corresponding sub-license has been issued, respective values of a “user ID” and a “viewing content” obtained as below.

The license issuing/renewing section refers to the value of an “associated license ID” included in a class lower than the class of the “license ID” retrieved. The license issuing/renewing section then, for each value it has referred to, refers to respective values of the “user ID” and “viewing content ID” for a main license having the above value as its “license ID”. In the case where there are N associated licenses, the license issuing/renewing section 420 transmits, to a single user terminal, N sets of the respective values the “user ID” and the “viewing content ID”.

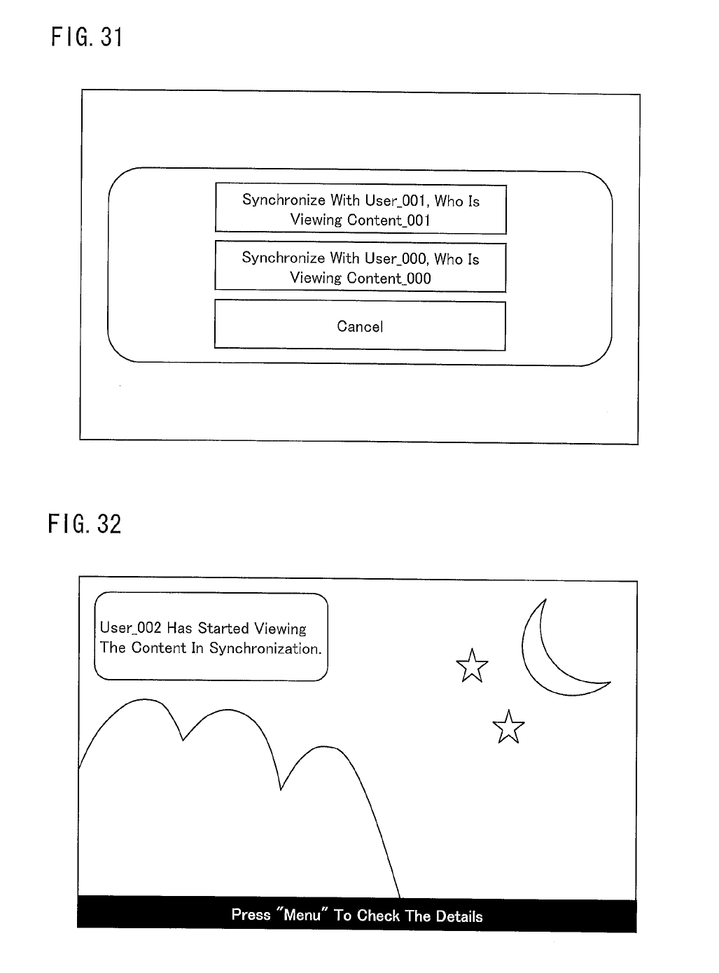

The user terminal that has received the values of the “user ID” and the “viewing content ID” in the step S28 displays a UI such as that in FIG. 31. The UI allows the user to select a content to view.

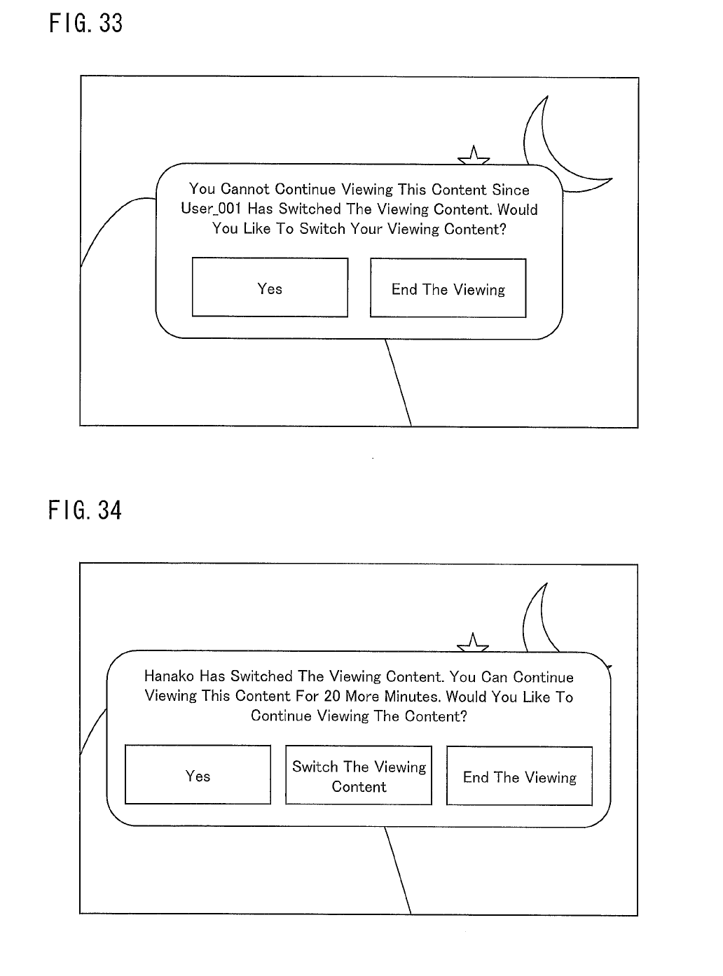

The user terminal that has received the value of the “synchronized content ID” in the step S26 displays a UI such as that in FIG. 33. If the user selects “Yes”, the content reproducing section 110 of the user terminal 100 transmits to the service provision server 300 a request for a content (hereinafter referred to simply as ‘content “Content_001”’) having the content ID “Content_001”. The UI in FIG. 33 may be replaced by the UI in FIG. 34 for display. The time period “20 minutes” in the UI in FIG. 34 indicates a remaining reproduction time period for a content being reproduced. In this case, if the user selects “Yes”, the content reproducing section 110 continues to reproduce the currently reproduced content until its end, and then transmits to the service provision server 300 a request for the content “Content_001”. The content reproducing section 110 desirably allows the currently reproduced content to be reproduced until its end only by normal reproduction.

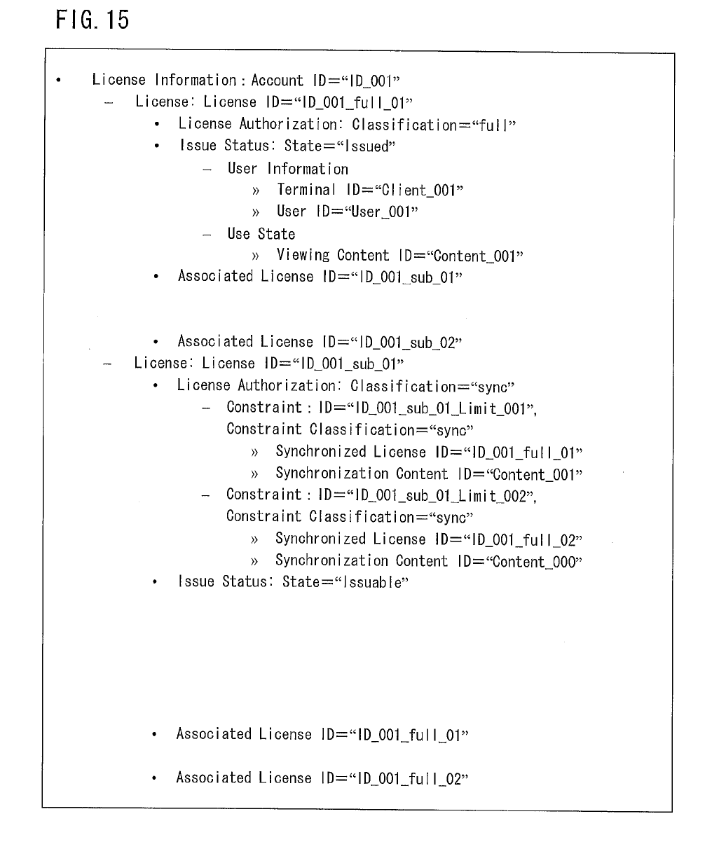

The description above deals with a processing operation of issuing the main license “ID_001_full_01”. If the main license “ID_001_full_02” is next issued to another user terminal, the license table will have values as shown in the license table S_L004_4 of FIG. 15.

In this state, even if still another user terminal 100 requests the license server to issue to the user terminal 100 a main license for reproducing the content “Content_001”, such a main license is not issuable, and only a sub-license is issuable.

The following describes a processing operation of issuing a sub-license for such a case.

(Sub-License Issuing Operation of License Server 400)

The license table, before a sub-license issuing operation, includes values as shown in the license table S_L004_4.

The description below refers to FIG. 3. First, the license issuing/renewing section 420 of the license server 400 receives, from the license obtaining section 121 of the user terminal 100, a request to use a sub-license (S1). The license use request includes a user name, an account ID, a content ID, and a terminal ID all inputted by the user. The license issuing/renewing section 420, upon receipt of such a use request, transmits an inquiry to the service providing section 310 about whether the use request is valid. More specifically, the license issuing/renewing section inquires about whether (i) the account ID included in the license use request is registered in the user account table 330 and (ii) the account ID and the terminal ID both included in the license use request respectively match the account ID and the terminal ID both included in the log-in request transmitted to the service provision server 300. The license issuing/renewing section 420, upon receipt of a notification from the service providing section 310 to the effect that the use request is valid, refers to the license table storing section 430 to refer to (i) the scope of right of a sub-license recorded in a license table for the account indicated by the account ID and (ii) the state (that is, whether the sub-license has been issued to any terminal) of issue of the sub-license (S2). The license issuing/renewing section 420 thus determines whether the sub-license requested is available (S3). Specifically, the license issuing/renewing section determines that a sub-license is available, in the case where the license table includes, recorded therein, a “license ID” having (i) an “issue status” of “issuable” and (ii) any “constraint” with its “synchronized content ID” that is equal in value to the content ID of a content to be reproduced. For instance, in the case where the license table includes values as shown in the license table S_L004_4, a “license ID” with the value “ID_001_sub_01” is followed by a constraint in which the “constraint ID” has the value “ID_001_sub_12_Limit_001”, the constraint having a “synchronized content ID” with the value “Content_001”, which equals the content ID of a content to be reproduced. The “license ID” with the value “ID_001_sub_01” is “issuable”. The license issuing/renewing section thus determines that the sub-license “ID_001_sub_01” is available.

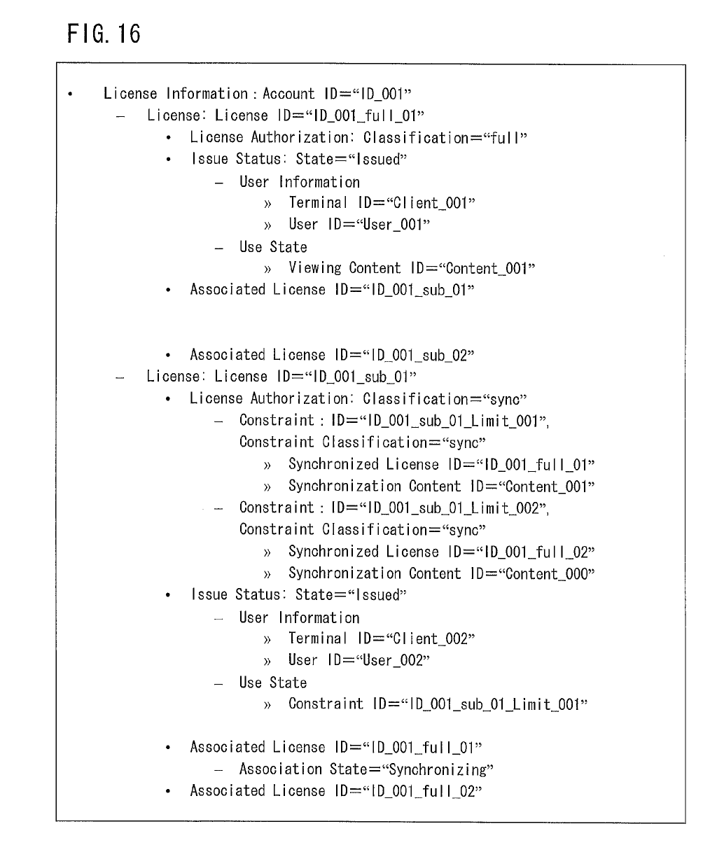

If the license issuing/renewing section has determined that a sub-license is available (YES in S3), the license authorization control section 412 updates a license use state recorded in the license table (S4). Specifically, the license authorization control section 412 sets the “issue status” for the “license ID” of the sub-license to be issued to “already issued”, and records the “terminal ID” and “user ID” as “user information”. The update of the license use state changes the values of the license table from the state of the license table S_L004_4 to the state of the license table S_L005 shown in FIG. 16.

The license issuing/renewing section 420 then determines whether there is any main license to be managed in association with the sub-license to be issued (S5). A main license to be managed in association with a sub-license refers specifically to a main license with a “license ID” having a value that is not recorded as the value of an “associated license ID” in a class lower than the class of the “license ID” of the sub-license.

If the license issuing/renewing section has determined that there is a main license to be managed in association (YES in S5), the license issuing/renewing section 420 associates (i) the sub-license to be issued with (ii) the main license to be managed in association therewith (S6). The process then proceeds to S7. If the license issuing/renewing section has determined that there is no main license to be managed in association, as in the case of the license table having the values shown in the license table S_L005 (NO in S5), the process directly proceeds to S7.

The license authorization control section 412 next starts a license synchronization processing (S7), and then issues the sub-license to the user terminal 100. The operation during the license synchronization processing is described later in detail.

The user terminal 100 (hereinafter referred to also as “sub-terminal 100”) that has received the sub-license transmits, to the service provision server 300, a request for a service. The service providing section 310, upon receipt of the request, transmits an inquiry to the license server 400 about whether the user terminal 100 has the authorization to use the service (that is, the authorization to reproduce the content “Content_001”). If the license server has, in response, informed the service provision server that the user terminal has the authorization, the service provision server provides the service to the user terminal 100 (S8), and ends the process. The following describes the step S8 in detail.

The content reproducing section 110 transmits to the service provision server 300 (i) the content ID “Content_001” included in the content use condition information and (ii) the license ID (“ID_001_sub_01”) in order to request the service provision server to issue a decoding key necessary to decode the “PROGRAM 1”.

When the service provision server 300 has accepted the request to issue a decoding key, the service providing section 310 retrieves the account ID of a user of the sub-terminal 100 from the user account table 330. The service providing section then transmits to the license server 400 (i) the account ID (“ID_001”), (ii) the license ID (“ID_001_sub_01”), and (iii) the content ID (“Content_001”) to inquire about whether to issue the decoding key. The license server 400, upon receipt of the inquiry, refers to the license table for the account ID (“ID_001”) received. In this example, the license table includes values as shown in the license table S_L005. In the license table, the license ID (“ID_001_sub_01”) (i) indicates “sync” for the classification of license authorization and (ii) includes a constraint having a synchronized content ID of “Content_001”. The license server 400 thus determines that the decoding key is issuable, and notifies the service provision server 300 to that effect.

When the service provision server 300 has received the notification to the effect that the decoding key is issuable, the service providing section 310 reads from the content table 320 the decoding key for decoding the content data of the program 1, and transmits the decoding key to the user terminal 100. The service providing section further notifies the license server 400 that the user terminal 100 has started reproduction of the program 1. When the user terminal 100 has received the decoding key, the content reproducing section 110 (i) accesses the content obtaining target URL included in the content use condition information received in advance, (ii) obtains encrypted content data of the program 1, and (iii) decodes the content data with use of the decoding key for reproduction of the program 1.

If the license issuing/renewing section has determined that a sub-license is unavailable (NO in S3), the license issuing/renewing section determines whether there is any service, other than the requested service, which should be suggested and for which a sub-license is issuable (S9).

If the license issuing/renewing section has determined that there is such a service to be suggested (YES in S9), the license issuing/renewing section causes the display section (not shown) of the user terminal 100 to display information on that service (S10), and ends the process. If the license issuing/renewing section has determined that there is no such service to be suggested (NO in S9), the license issuing/renewing section causes the user terminal 100 to display an UI such as that in FIG. 28, and ends the sub-license issuing process.

The following describes, with reference to FIG. 4, the license synchronization processing included in the above-described series of steps for issuing a sub-license.

FIG. 4 is a flowchart illustrating a flow of the license synchronization operation by the license server 400.

The license authorization control section 412 notifies the service use status change detecting section 411 that a sub-license has been issued, in response to which the service use status change detecting section 411 notifies the license authorization control section 412 that a sub-license has been issued (S21). The processing then proceeds to S23 (no particular operation is carried out in S22 for the sub-license issuing processing).

The license authorization control section 412 then checks whether the license ID “ID_001_sub_01” in the license table S_L005 is immediately followed by a lower class including an “associated license ID”, and consequently checks whether there is any associated license associated with the sub-license issued to the user terminal 100 (S23). If the license authorization control section has determined that there is no associated license (NO in S23), the license authorization control section ends the processing. If the license authorization control section has determined that there is an associated license (YES in S23), the processing proceeds to the step S24.

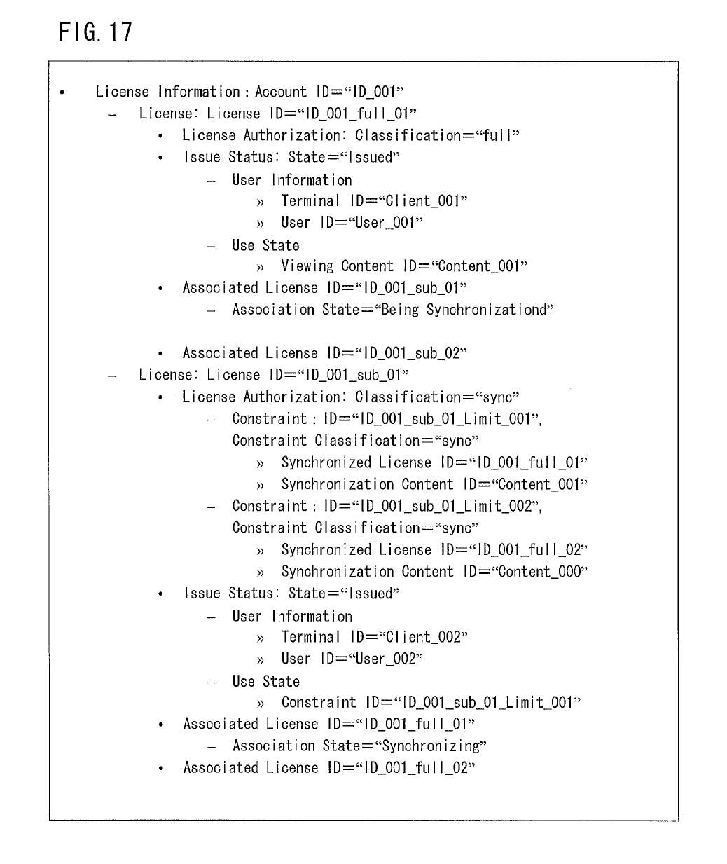

The license authorization control section 412 in S24 notifies a user terminal 100 to which the associated license (main license) has been issued that a user terminal to which a sub-license has been issued has started synchronization reproduction. Specifically, the license authorization control section carries out an operation in S61 of (d) of FIG. 5 to update the license table to the state of the license table S_L006 in FIG. 17. More specifically, the license authorization control section 412 sets the “association state” of an “associated license ID” to “being synchronized” which “associated license ID” is (i) included in a class lower than the class of a “license ID” equal in value to the associated license (license ID: ID_001_full_01) and (ii) equal in value to the license ID of the issued sub-license. During this step, the user terminal 100 to which the main license has been issued and which has been notified as above may cause a display section thereof to display a UI, such as that in FIG. 32, which indicates that another user has started synchronization viewing at a terminal to which a sub-license has been issued. The example UI in FIG. 32 shows, as the user ID of another user, “User_002”, which is obtained by referring to the license table S_L006 for the value (“User_002”) of “user information” for the issued sub-license (license ID: ID_001_sub_01).

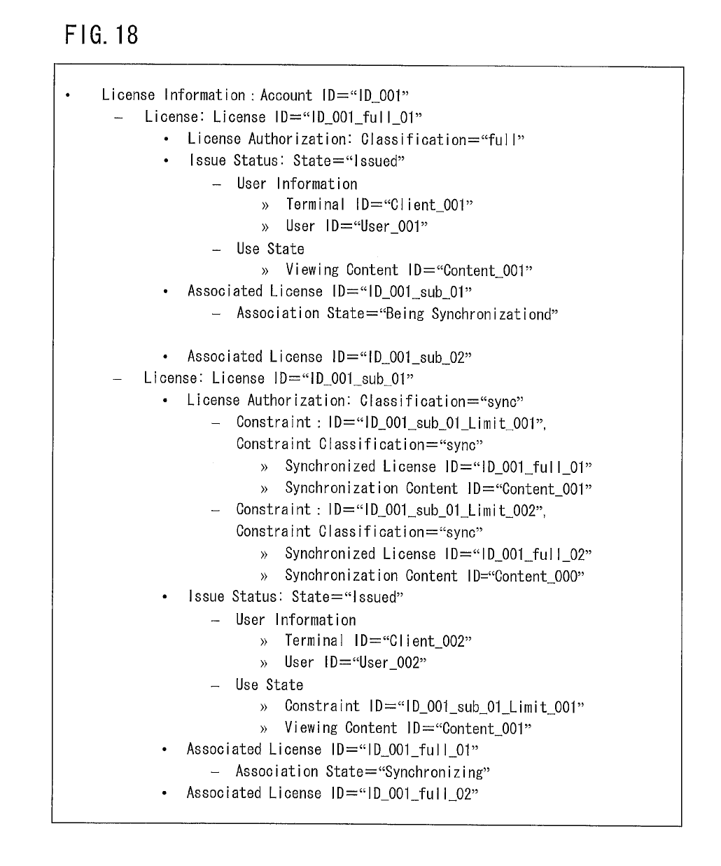

The license authorization control section 412 further updates the license table to the state of the license table S_L006_2 in FIG. 18. Specifically, the license authorization control section 412, for the associated license (license ID: ID_001_full_01) associated with the issued sub-license (license ID: ID_001_sub_01), records a “viewing content ID” having a value of the content ID (“Content_001”), for which an inquiry has been made in S8 about whether the user terminal has the authorization to reproduce the content.

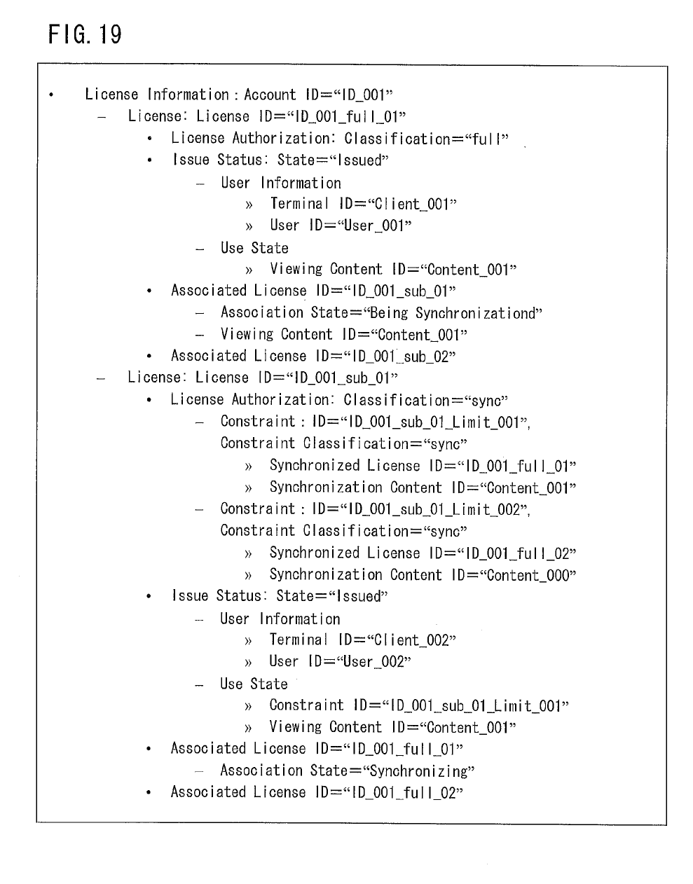

Finally, the license authorization control section 412 carries out an operation in S61 of (d) of FIG. 5 to update the license table to the state of the license table S_L006_3 in FIG. 19. Specifically, the license authorization control section 412, for the “associated license ID” that is (i) included in a class lower than the class of a “license ID” equal in value to the associated license (license ID: ID_001_full_01) and (ii) equal in value to the license ID of the issued sub-license, records, as a value of the “viewing content ID”, the content ID (“Content_001”) for which an inquiry has been made in S8 about whether the user terminal has the authorization to reproduce the content.

The above step in S24 concludes the processing of license synchronization for issue of a sub-license (the step S25 and its subsequent steps are carried out for the processing of license synchronization for issue of a main license).

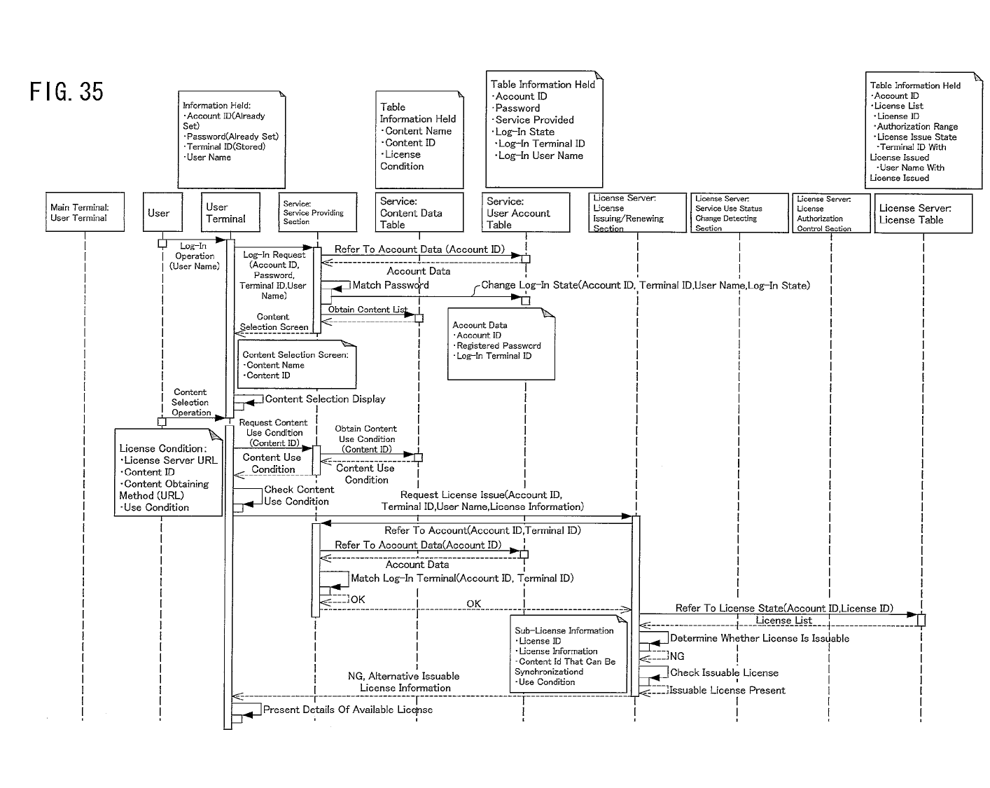

The above-described main-license issuing and sub-license issuing operations are detailed respectively in FIGS. 35 through 37 and FIGS. 39 through 41.

(Operation Carried Out when User Terminal 100 to which Main License has been Issued Switches Contents to be Reproduced (Main-License Content Switch Following Operation))

With reference to FIGS. 4, 5, 7, 21-24, and 29, the following description deals with an operation carried out by the license provision system in the case where a user terminal 100 to which the main license “ID_001_full_01” has been issued switches its reproducing content from the content “content_001” to the content “content_002”. The description below assumes that before the switch of the reproducing content, (i) a user terminal 100 (hereinafter referred to as “sub-terminal 100”) to which the sub-license “ID_001_sub_01” has been issued synchronizes with the main terminal 100 and is reproducing the content “content_001”, and (ii) the license table includes the values of the license table S_L006.

In the case where a user of the main terminal 100 intends to switch a viewing content and carries out an operation for displaying a content selecting screen such as that in FIG. 29, the main terminal 100 transmits a content list request to the service provision server 300 to receive a content list. The service provision server 300 may require a log-in processing in order to determine whether to transmit a content list to the main terminal 100. The service provision server may alternatively omit such a log-in processing by identifying, on the basis of a session ID transmitted from the main terminal 100, the main terminal 100 that has transmitted the content list request.

The main terminal 100, upon receipt of the content list, causes a display section thereof to display the content selecting screen illustrated in FIG. 29. If the user has selected the “PROGRAM 2” (content “Content_002”), the content reproducing section 110 of the main terminal 100 transmits to the service provision server 300 a request for content use condition information for the program 2. The service providing section 310 of the service provision server 300, in return, transmits the content use condition information for the program 2 to the main terminal 100.

When the main terminal 100 has received the content use condition information, the content reproducing section 110 transmits to the service provision server 300 (i) the content ID “Content_002” included in the content use condition information and (ii) the license ID “ID_001_full_01” in order to request the service provision server to issue a decoding key necessary to decode the “PROGRAM 2”.

When the service provision server 300 has accepted the request to issue a decoding key, the service providing section 310 retrieves the account ID of the user of the main terminal 100 from the user account table 330. The service providing section then transmits to the license server 400 (i) the account ID (“ID_001”), (ii) the license ID (“ID_001_full_01”), and (iii) the content ID (“Content_002”) to inquire about whether to issue the decoding key. The license server 400, upon receipt of the inquiry, refers to the license table for the account ID (“ID_001”) received. In this example, the license table includes values as shown in the license table S_L006. In the license table, the license ID (“ID_001_full_01”) indicates “full” for the classification of license authorization. The license server 400 thus determines that the decoding key is issuable, and notifies the service provision server 300 to that effect.

When the service provision server 300 has received the notification to the effect that the decoding key is issuable, the service providing section 310 reads from the content table 320 the decoding key for decoding the content data of the program 2, and transmits the decoding key to the main terminal 100. The service providing section further notifies the license server 400 that the main terminal 100 has started reproduction of the program 2. When the main terminal 100 has received the decoding key, the content reproducing section 110 (i) accesses the content obtaining target URL included in the content use condition information received in advance, (ii) obtains encrypted content data of the program 2, and (iii) decodes the content data with use of the decoding key for reproduction of the program 2.

The following describes, with reference to FIG. 4, an operation carried out by the license server 400 upon receipt of a notification that the main terminal 100 has started reproduction of the program 2.

When the license server 400 has received the notification, the service use status change detecting section 411 notifies the license authorization control section 412 that the main terminal 100 has started reproduction of the program 2 (S21).

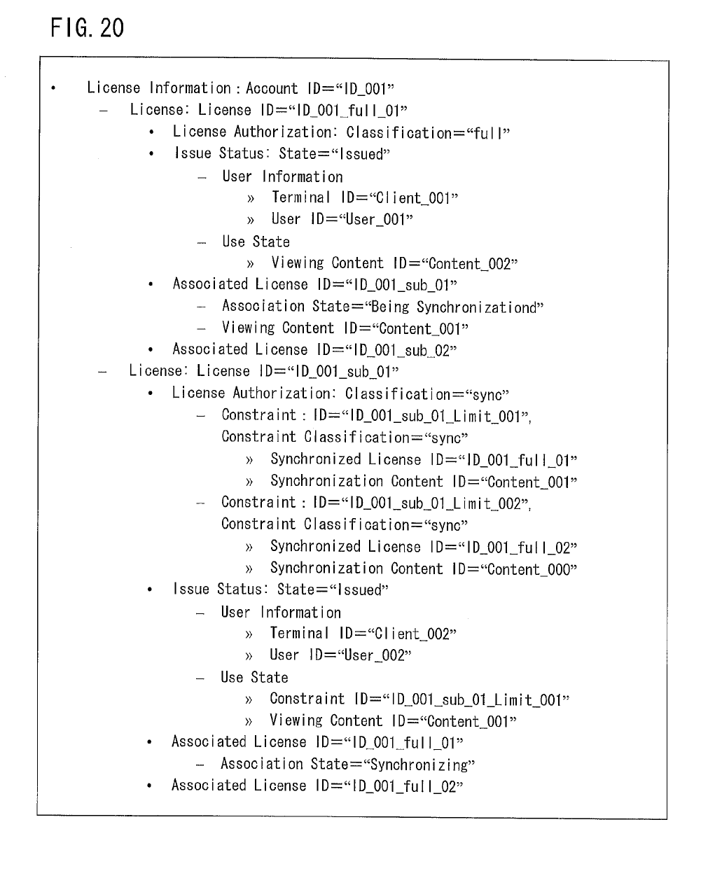

The license authorization control section 412 records, in the license table, the switch by the main terminal 100 of its reproducing content (S22). Specifically, the license authorization control section 412 changes the value of a “viewing content ID”, included in a class lower than the class of a “license ID” having the value “ID_001_full_01”, from “Content_001” to “Content_002”. The license authorization control section thus changes the values of the license table to the state of the license table S_L007 in FIG. 20.

The license authorization control section 412 checks (i) the use state for the license ID (“ID_001_full_01”) and (ii) details of a change to that use state in order to determine whether there is any associated license (S23). Specifically, the license authorization control section refers to the license table to check whether any “license ID” with the value “ID_001_full_01” is followed by a lower class including an “associated license ID”. The license table, which currently includes the values of the license table S_L007, includes associated license ID's with the respective values “ID_001_sub_01” and “ID_001_sub_02”.

If the license authorization control section has determined that there is no associated license (NO in S23), the license authorization control section ends the process.

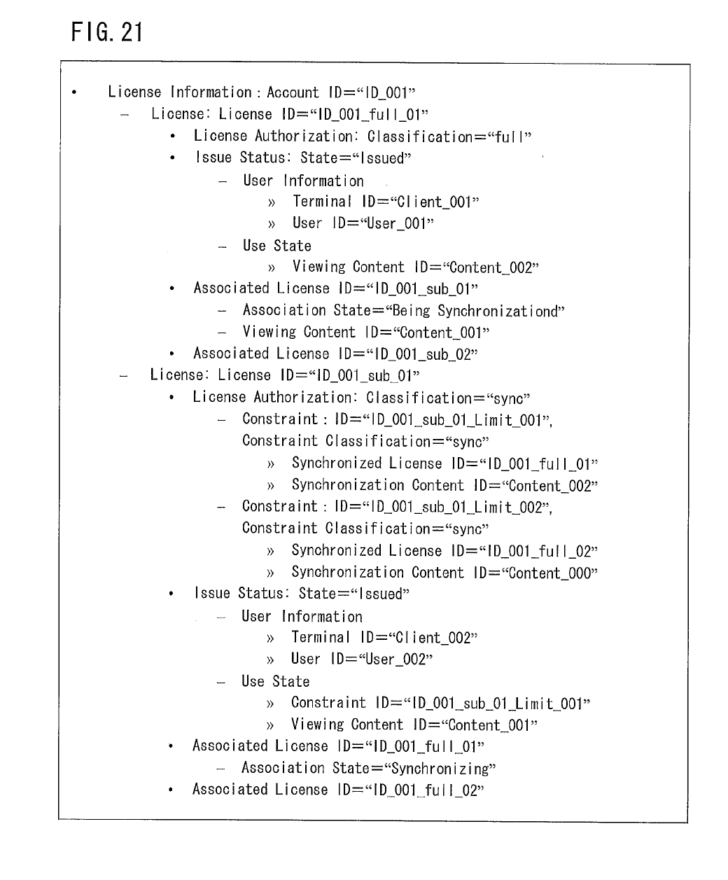

If the license authorization control section has determined that there is an associated license as in the case of the license table including the values of the license table S_L007 (YES in S23), the license authorization control section 412 changes details of a service that can be provided to another terminal that is associated (S24). Specifically, the license authorization control section carries out an operation in S51 of (c) of FIG. 5 to record, in the license table, information indicating that another terminal to which the license indicated by the associated license ID has been issued is permitted to reproduce only the content “Content_002”. In other words, the license authorization control section changes the value of a “synchronized content ID” to “Content_002” for, among “constraints” with a “license ID” of “ID_001_sub_01”, the “constraint” having a “synchronized license ID” of “ID_001_full_01”. The license authorization control section thus changes the values of the license table to the state of the license table S_L008 in FIG. 21.

The above step in S24 concludes the processing carried out by the license server 400 in the case where the main terminal 100 has switched its reproducing content.

The following describes, with reference to FIG. 3, an operation carried out by the license server 400 when a license issued to a sub-terminal 100 has become close to its expiration time.

The license renewing section 122 of the sub-terminal 100, when the license has reached its expiration time, transmits to the license server 400 a license renewal request, that is, a request to renew the sub-license (“ID_001_sub_01”) held by the sub-terminal itself. The license issuing/renewing section 420 of the license server 400 thus receives the license renewal request (S1).

The license issuing/renewing section 420, in response, refers to the service use status for the sub-license of “ID_001_sub_01” (S2). The license issuing/renewing section 420, on the basis of the service use status that it has referred to, determines whether the sub-license requested is renewable and issuable (S3). If the license issuing/renewing section has determined that the sub-license requested is not renewable and issuable (NO in S3), the license issuing/renewing section proceeds to the step S9. The step S9 and its subsequent steps are similar to those carried out during the sub-license issuing operation. The following thus omits a description thereof.

If the license issuing/renewing section has determined that the sub-license requested is renewable and issuable (YES in S3), the license issuing/renewing section 420 determines whether there has been any change to the license authorization since the immediately previous issue of the license. If the license issuing/renewing section has determined that there has been such a change, the license issuing/renewing section 420 (i) issues a renewed sub-license to the sub-terminal 100 and (ii) notifies the sub-terminal 100 that the content reproducible on the basis of the sub-license has been changed to the content “Content_002” (program 2) (S8). The license issuing/renewing section then ends the process. If the license issuing/renewing section has determined that there has been no such change, the license issuing/renewing section 420 carries out only the processing of issuing a renewed sub-license to the sub-terminal 100. The steps S4 through S7 are carried out for issue of a new license, and are not carried out for issue of a renewed license.

The sub-terminal 100, upon receipt of a notification during the step S8, ends the reproduction of the content “content_001” and causes a display section thereof to display a UI such as that in FIG. 33. If the user of the sub-terminal 100 has selected “Yes”, the content reproducing section 110 of the sub-terminal 100 switches its reproducing content to the program 2, in which case the license provision system carries out an operation described below.

The content reproducing section 110 of the sub-terminal 100 transmits, to the service provision server 300, a request for content use condition information for the program 2. The service providing section 310 of the service provision server 300, in return, transmits the content use condition information for the program 2 to the sub-terminal 100.

When the sub-terminal 100 has received the content use condition information, the content reproducing section 110 transmits to the service provision server 300 (i) the content ID “Content_002” included in the content use condition information and (ii) the license ID “ID_001_sub_01” in order to request the service provision server to issue a decoding key necessary to decode the “PROGRAM 2”.

When the service provision server 300 has accepted the request to issue a decoding key, the service providing section 310 retrieves the account ID of the user of the sub-terminal 100 from the user account table 330. The service providing section then transmits to the license server 400 (i) the account ID (“ID_001”), (ii) the license ID (“ID_001_sub_01”), and (iii) the content ID (“Content_002”) to inquire about whether to issue the decoding key. The license server 400, upon receipt of the inquiry, refers to the license table for the account ID (“ID_001”) received. In this example, the license table includes values as shown in the license table S_L008. In the license table, the license ID (“ID_001_sub_01”) (i) indicates “sync” for the classification of license authorization and (ii) includes a constraint having a synchronized content ID of “Content_002”. The license server 400 thus determines that the decoding key is issuable, and notifies the service provision server 300 to that effect.

When the service provision server 300 has received the notification to the effect that the decoding key is issuable, the service providing section 310 reads from the content table 320 the decoding key for decoding the content data of the program 2, and transmits the decoding key to the sub-terminal 100. The service providing section further notifies the license server 400 that the sub-terminal 100 has started reproduction of the program 2. When the sub-terminal 100 has received the decoding key, the content reproducing section 110 (i) accesses the content obtaining target URL included in the content use condition information received in advance, (ii) obtains encrypted content data of the program 2, and (iii) decodes the content data with use of the decoding key for reproduction of the program 2.

When the license server 400 has received the notification, the service use status change detecting section 411 notifies the license authorization control section 412 that the sub-terminal 100 has started reproduction of the program 2 (S21).

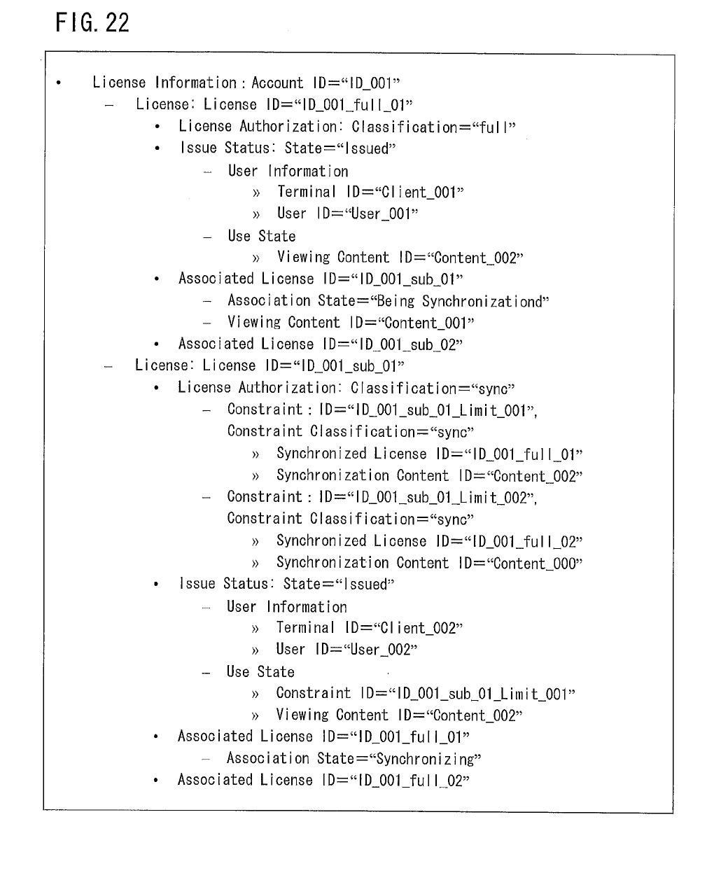

The license authorization control section 412 records, in the license table, the switch of the content reproduced by the sub-terminal 100 for which the sub-license “ID_001_sub_01” has been renewed and to which it has been issued (S22). Specifically, the license authorization control section 412 changes the value of a “viewing content ID”, included in a class lower than the class of a “license ID” having the value “ID_001_sub_01”, from “Content_001” to “Content_002”. The license authorization control section thus changes the values of the license table to the state of the license table S_L009 in FIG. 22.

The license authorization control section 412 checks (i) the use state for the license ID (“ID_001_sub_01”) and (ii) details of a change to that use state in order to determine whether there is any associated license (S23). Specifically, the license authorization control section refers to the license table to check whether any “license ID” with the value “ID_001_sub_01” is followed by a lower class including an “associated license ID”. The license table, which currently includes the values of the license table S_L009, includes associated license ID's with the respective values “ID_001_full_01” and “ID_00 1_full_02”.

If the license authorization control section has determined that there is no associated license (NO in S23), the license authorization control section ends the process.

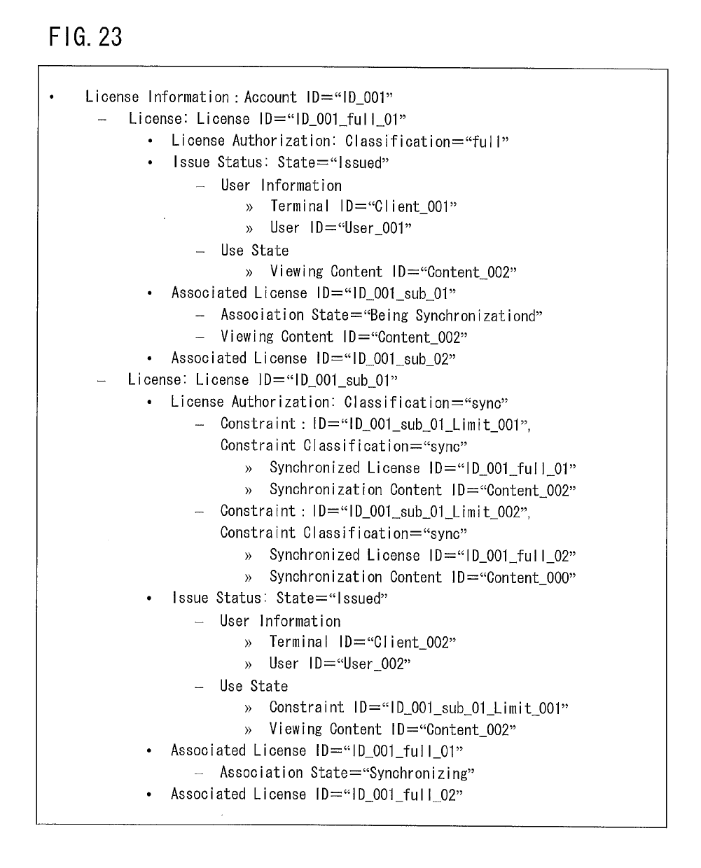

If the license authorization control section has determined that there is an associated license as in the case of the license table including the values of the license table S_L009 (YES in S23), the license authorization control section 412 records, in the license table, the switch of the content reproduced by the sub-terminal 100 for which a sub-license has been renewed and to which it has been issued (S24). Specifically, the license authorization control section carries out an operation in S81 of (f) of FIG. 5 in order to change, for “license ID's” with the values “ID_001_full_01” and “ID_001_full_02”, the value of a “viewing content ID” for an “associated license ID” of “ID_001_sub_01” to “Content_002”. The license authorization control section thus changes the values of the license table to the state of the license table S_L010 in FIG. 23.

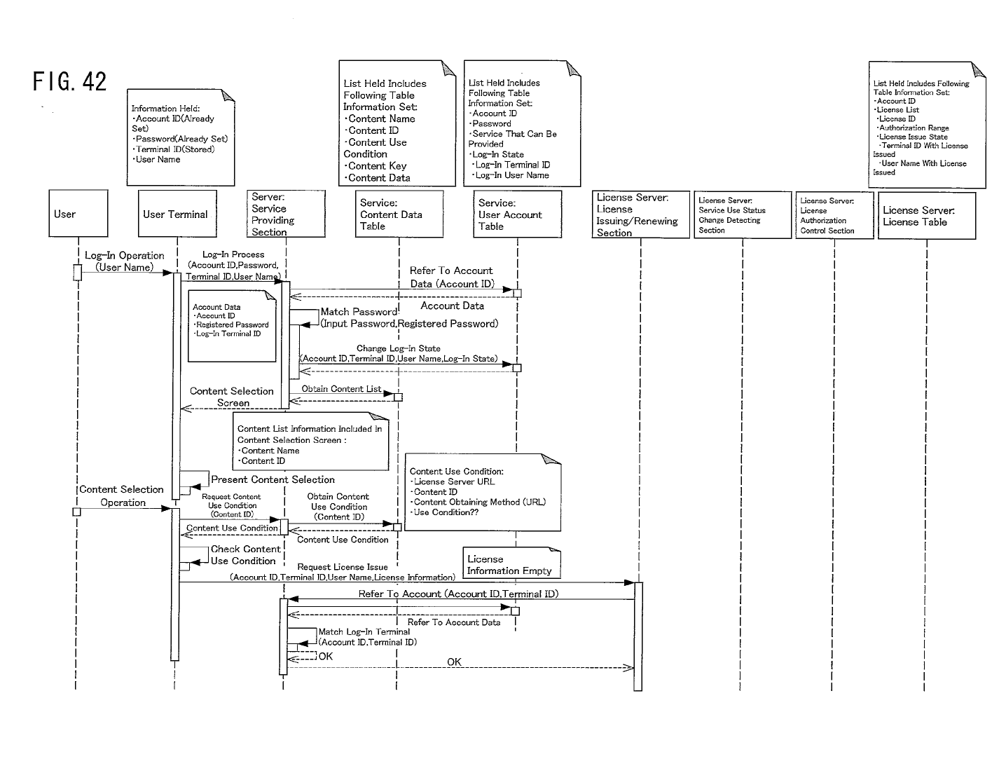

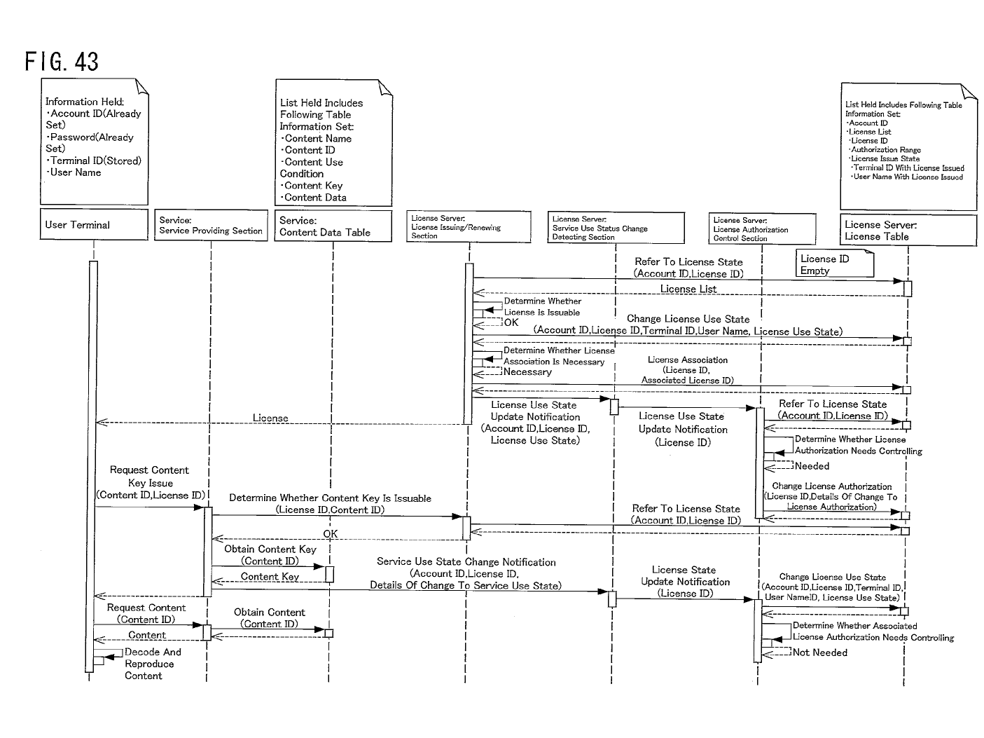

The above step in S24 concludes the processing carried out by the license server 400 in the case where the sub-terminal 100 has switched its reproducing content. The above-described main-license switch following operation is detailed in FIGS. 42 and 43.

As described above, when a sub-license issued to a sub-terminal 100 has reached its expiration time, the license server 400 renews the sub-license and issues it to the sub-terminal 100. The license issuing/renewing section 420 in S2 may refer to the service use status for a corresponding main license before referring to the service use status for the sub-license of “ID_001_sub_01”. Then, the license issuing/renewing section 420, if there is an issuable main license, may issue the main license to the sub-terminal 100.

(Operation of Main Terminal 100 for Ending Reproduction of Content and Returning Main License to License Server 400)

The following describes, with reference to FIG. 5, an operation carried out by the license provision system in the case where a main terminal 100 has ended reproduction of the content “content_002”.

When a user of the main terminal 100 has carried out an operation for stopping reproduction of a content, the content reproducing section 110 of the main terminal 100 notifies the service provision server 300 that the main terminal has ended the reproduction of the content.

The service providing section 310 of the service provision server 300, in response, notifies the license server 400 that the main terminal 100 has ended the reproduction of the content.

When the license server 400 has received the notification, the service use status change detecting section 411 notifies the license authorization control section 412 that the main terminal 100 has stopped the reproduction of the content (S21).

In response, the license authorization control section 412, by following the flowchart of (b) of FIG. 5, records, in the license table, the stop by the main terminal 100 of the reproduction of the content (S22). Specifically, the license authorization control section 412, for each sub-license indicated by an “associated license ID” having a “license ID” with the value “ID_001_full_01”, deletes a “constraint” having a “synchronized license ID” of “ID_001_full_01” (S41).

The license authorization control section 412 then (i) for each sub-license, deletes any “associated license ID” having the value “ID_001_full_01”, and (ii) for each “license ID” of “ID_001_full_01”, deletes an “associated license ID” and changes the “issue status” to “issuable” (S42).

Further, the license authorization control section 412, for each sub-license having no “constraint” or “associated license ID”, changes the “issue status” to “not issuable” (S43).

(Operation of Sub-Terminal 100 for Ending Reproduction of Content and Returning Sub-License to License Server 400)

The following describes, with reference to FIG. 5, an operation carried out by the license provision system in the case where a sub-terminal 100 has ended reproduction of the content “content_002”.

When a user of the sub-terminal 100 has carried out an operation for stopping reproduction of a content, the content reproducing section 110 of the sub-terminal 100 notifies the service provision server 300 that the sub-terminal has stopped the reproduction of the content.

The service providing section 310 of the service provision server 300, in response, notifies the license server 400 that the sub-terminal 100 has ended the reproduction of the content.

When the license server 400 has received the notification, the service use status change detecting section 411 notifies the license authorization control section 412 that the sub-terminal 100 has stopped the reproduction of the content.

In response, the license authorization control section 412, by following the flowchart of (e) of FIG. 5, records, in the license table, the stop by the sub-terminal 100 of the reproduction of the content (S22). Specifically, the license authorization control section 412 (i) for each “license ID” with the value “ID_001_full_01”, deletes an “associated license ID” that is included in a class lower than the class of the “license ID” and that has the value “ID_001_sub_01”, and (ii) for each “license ID” having the value “ID_001_sub_01”, changes the “issue status”, included in a class lower than the class of the “license ID”, to “issuable” (S71).

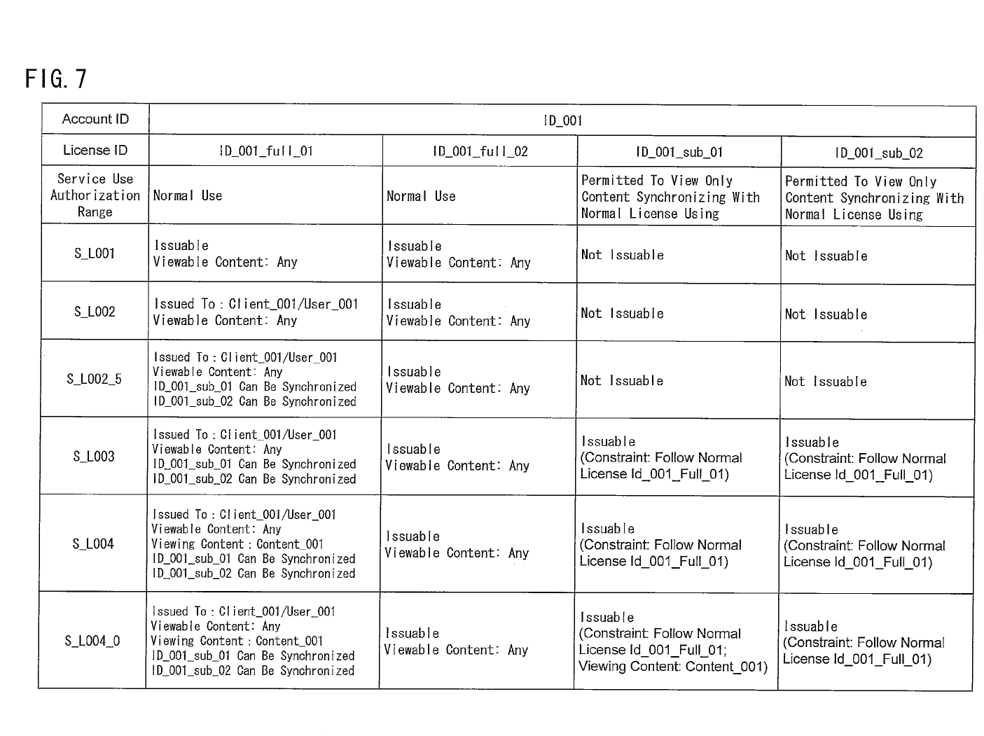

The description above deals with operations by the license server 400 for (i) issuing a license to a user terminal 100, (ii) collecting a license from a user terminal 100, and (iii) changing the scope of right of a sub-license. The description above clearly indicates that the individual operations are carrying out by referring to and renewing the license table, and that the license table plays an important role in the present embodiment. FIGS. 7 through 9 are each a table that shows the relation of values of the license table to (i) whether a license is issuable and (ii) the scope of right of a license to help understand the relation.

(Advantage of License Server 400)

As described above, the license server 400 (operation control device) controls each user terminal 100 on the basis of a license including a main license and a sub-license, the main license permitting a user terminal 100 to reproduce any content, the sub-license permitting a user terminal 100 to reproduce only a content that is identical to a content that is being reproduced by another user terminal 100.

The service use status change detecting section 411 detects that a user terminal 100 to which a main license has been issued has switched its reproducing content to the content “Content_002”. Further, when such a change is thus detected, the license authorization control section 412 changes the license table so that the value of a “synchronized content ID” in a “constraint” is set to “Content_002”. With this operation, the content reproducible by another user terminal 100 on the basis of a sub-license is changed to the content “Content_002”.

The embodiment above describes an operation carried out, in the case where a user terminal 100 to which a main license has been issued has switched its reproducing content to the content “Content_002”, subsequently by a user terminal to which a sub-license has been issued. Needless to say, a similar operation is carried out even in the case where the reproducing content has been switched to any other content having a content ID with a value other than the value “Content_002”. In other words, regardless of the content to which the user terminal 100 has switched a content that it reproduces on the basis of a main license, another user terminal 100 is permitted to reproduce, on the basis of a sub-license, only a content that is to be reproduced by the above user terminal 100 on the basis of the main license after the above switch.

The license server 400 can thus, without causing a loss in the benefit for a license provider, cause a content reproducing operation based on a license to be carried out by a plurality of user terminals 100 on the basis of such a single license.

### Embodiment 2

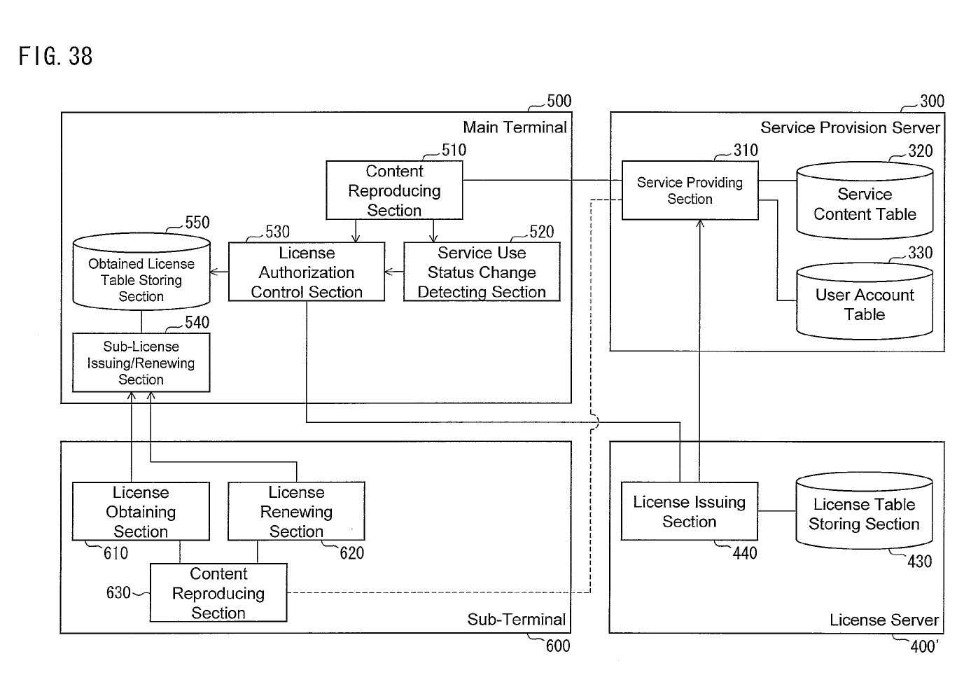

With reference to FIG. 38, the description below deals, in accordance with another embodiment of the present invention, with a license provision system including (i) a license server, (ii) a service provision server, and (iii) user terminals, all communicably connected to one another.

FIG. 38 is a block diagram illustrating a configuration of a license provision system of the present embodiment, the license provision system including (i) a license server, (ii) a service provision server, and (iii) user terminals (namely, a main terminal and a sub-terminal), all communicably connected to one another.

The license provision system, as illustrated in FIG. 38, includes: a service provision server 300; a license server 400′; a main terminal 500; and a sub-terminal 600.

The service provision server 300 carries out such processes as (i) authentication of a user intending to use a service, (ii) presentation, to the main terminal 500 and the sub-terminal 600, of a screen allowing selection of a content to be reproduced, and (iii) distribution of a content to the main terminal 500 and the sub-terminal 600.

The main terminal 500 requests the service provision server 300 to distribute a content, and thus reproduces a distributed content. The main terminal 500, if holding no license to reproduce a content, requests the license server 400 to issue a main license to the main terminal 500. The main terminal 500 further serves to (i) manage a sub-license obtained from the license server 400, (ii) accept, from the sub-terminal 600, a request to issue a sub-license for reproducing a content, and (iii) issue a sub-license to the sub-terminal 600.

The sub-terminal 600 requests the service provision server 300 to distribute a content, and thus reproduces a distributed content. The sub-terminal 600, if holding no license to reproduce a content, requests the main terminal 500 to issue a sub-license to the sub-terminal 600.

The license server 400 is a server that issues a main license and a sub-license to the main terminal 500.

The following describes, with reference to FIG. 38, respective configurations of the license server 400′, the main terminal 500, and the sub-terminal 600. The description below does not deal in detail with the service provision server 300 included in the license provision system of the present embodiment since the service provision server is identical to that of Embodiment 1 as illustrated in FIG. 38. The service provision server 300 of the present embodiment, however, provides the sub-terminal 600 with content use condition information that includes, not a license server URL, but a main terminal URL. The main terminal URL is a URL for the main terminal 500, to which a sub-license is issued. When the license server 400′ issues a sub-license to the main terminal 500, the license server 400′ transmits a main terminal URL to the service provision server 300, of which the service content table 320 stores the main terminal URL. When the main terminal 500 returns a sub-license, the license server 400′ notifies the service provision server 300 to that effect, whereby the main terminal URL is deleted from the service content table 320.

The license server 400′ includes: a license table storing section 430; and a license issuing section 440. The license table storing section 430 is identical to that of Embodiment 1. The license issuing section 440, on the other hand, issues a main license and a sub-license, but differs from the license issuing/renewing section 420 of Embodiment 1 in that it updates and manages only information on (i) whether a sub-license has been issued and (ii) the terminal to which a sub-license has been issued. Thus, the license issuing section 440 carries out no sub-license renewing processing to be carried out when a sub-license has reached its expiration time.

The main terminal 500 includes: a content reproducing section 510; a service use status change detecting section 520; a license authorization control section 530; a sub-license issuing/renewing section 540; and an obtained license table storing section 550.

The content reproducing section 510 obtains a content from the service provision server 300 and reproduces the content.

The service use status change detecting section 520 detects that the content reproducing section 510 has changed a reproducing content, and notifies the license authorization control section 530 to that effect.

The license authorization control section 530, when a content is to be reproduced for the first time, transmits to the license server 400′ a request for (i) a main license for reproducing the content and (ii) an issuable sub-license. Further, upon acceptance of a notification from the service use status change detecting section 520, the license authorization control section (i) checks the content ID of a content being reproduced by the content reproducing section 510 and (ii) updates the values of the license table recorded in the obtained license table storing section 550. The license authorization control section thus controls the scope of right of a sub-license.

The sub-license issuing/renewing section 540, in response to a request from the sub-terminal 600, carries out operations such as issuing a sub-license to the sub-terminal 600 and renewing a sub-license recorded in the sub-terminal 600.

The obtained license table storing section 550 includes, recorded therein, a license table indicative of (i) the scope of right of a license granted to the account of a user of the main terminal 500 and (ii) the terminal to which a license has been issued.

The sub-terminal 600 includes: a license obtaining section 610; a license renewing section 620; and a content reproducing section 630. The content reproducing section 630 obtains a content from the service provision server 300 and reproduces the content.

The license obtaining section 610 requests the main terminal 500 to issue a sub-license to the sub-terminal 600, and thus obtains a sub-license. The license renewing section 620 requests the main terminal 500 to renew a sub-license.

The description below deals in detail with a feature of the present embodiment, that is, an operation by which the main terminal 500 issues a sub-license to the sub-terminal 600. The license server 400′ issues a main license to the main terminal 500 by an operation similar to that of Embodiment 1. The description below thus does not deal therewith. During this operation, however, the main terminal 500 additionally obtains a sub-license and records its license information in the license table of the obtained license table storing section 550. Whether the main terminal 500 requests a sub-license other than a main license is desirably switchable through a user's operation or settings for the main terminal 500. When the main terminal 500 returns a main license to the license server 400′, it simultaneously returns a sub-license associated with the main license. During this operation, license information on that sub-license is deleted from the license table of the obtained license table storing section 550.

The description below assumes that before a sub-license issuing operation, the license table includes values as shown in the license table S_L004_4.

The sub-terminal 600 transmits a log-in request to the service provision server 300. The service providing section 310 of the service provision server 300, in response, carries out an authentication with reference to the user account table 330. If the service providing section has successfully carried out an authentication, the service provision server, in return, notifies the user terminal 100 of the success in the authentication, and transmits to the user terminal a list of contents stored in the service content table 320. The sub-terminal 600, in response, causes a display section (not shown) to display a UI such as the UI illustrated in FIG. 29.

If the user has selected a content (for example, “PROGRAM 1” in FIG. 29), the sub-terminal 600 transmits an inquiry to the service provision server 300 about a content use condition for the selected content. The service providing section 310 of the service provision server 300, in response, refers to the service content table 320 to transmit, back to the sub-terminal, content use condition information.

When the sub-terminal 600 has received the content use condition information, the license obtaining section 121 of the sub-terminal requests a main terminal 500, specified by the main terminal URL included in the content use condition information, to issue a sub-license to the sub-terminal 600.

(Sub-License Issuing Operation of Main Terminal 500)

The description below refers to FIG. 3. First, the sub-license issuing/renewing section 540 of the main terminal 500 receives, from the sub-terminal 600, a request to use a sub-license (S1). The license use request includes a content ID. The sub-license issuing/renewing section 540 refers to the obtained license table storing section 550 to refer to (i) the scope of right of a sub-license recorded in the license table and (ii) the state (that is, whether the sub-license has been issued to any terminal) of issue of the sub-license (S2). The sub-license issuing/renewing section 540 thus determines whether the sub-license requested is available (S3). Specifically, the sub-license issuing/renewing section determines that a sub-license is available, in the case where the license table includes, recorded therein, a “license ID” having (i) an “issue status” of “issuable” and (ii) any “constraint” with its “synchronized content ID” that is equal in value to the content ID of a content to be reproduced. For instance, in the case where the license table includes values as shown in the license table S_L004_4, a “license ID” with the value “ID_001_sub_01” is followed by a constraint in which the “constraint ID” has the value “ID_001_sub_01_Limit_001”, the constraint having a “synchronized content ID” with the value “Content_001”, which equals the content ID of a content to be reproduced. The “license ID” with the value “ID_001_sub_01” is “issuable”. The sub-license issuing/renewing section thus determines that the sub-license “ID_001_sub_01” is available.

If the sub-license issuing/renewing section has determined that a sub-license is available (YES in S3), the sub-license issuing/renewing section 540 updates a license use state recorded in the license table (S4). Specifically, the sub-license issuing/renewing section 540 sets the “issue status” for the “license ID” of the sub-license to be issued to “already issued”, and records the “terminal ID” and “user ID” as “user information”. The update of the license use state changes the values of the license table from the state of the license table S_L004_4 to the state of the license table S_L005 shown in FIG. 16.

The sub-license issuing/renewing section 540 then determines whether there is any main license to be managed in association with the sub-license to be issued (S5). A main license to be managed in association with a sub-license refers specifically to a main license with a “license ID” having a value that is not recorded as the value of an “associated license ID” in a class lower than the class of the “license ID” of the sub-license.

If the sub-license issuing/renewing section has determined that there is a main license to be managed in association (YES in S5), the sub-license issuing/renewing section 540 associates (i) the sub-license to be issued with (ii) the main license to be managed in association therewith (S6). The process then proceeds to S7. If the sub-license issuing/renewing section has determined that there is no main license to be managed in association, as in the case of the license table having the values shown in the license table S_L005 (NO in S5), the process directly proceeds to S7.

The sub-license issuing/renewing section 540 next starts a license synchronization processing (S7), and then issues the sub-license to the sub-terminal 600.

The sub-terminal 600 that has received the sub-license transmits, to the service provision server 300, a request for a service. The service providing section 310, upon receipt of the request, transmits an inquiry to the license server 400 about whether the sub-terminal 600 has the authorization to use the service (that is, the authorization to reproduce the content “Content_001”). If the license server has, in response, informed the service provision server that the sub-terminal has the authorization, the service provision server provides the service to the sub-terminal 600 (S8), and ends the process. The following describes the step S8 in detail.

The content reproducing section 630 transmits to the service provision server 300 (i) the content ID “Content_001” included in the content use condition information and (ii) the license ID (“ID_001_sub_01”) in order to request the service provision server to issue a decoding key necessary to decode the “PROGRAM 1”.

The service providing section 310 of the service provision server 300, in response, reads from the content table 320 the decoding key for decoding the content data of the program 1, and transmits the decoding key to the sub-terminal 600. The service providing section further notifies the main terminal 500 that the sub-terminal 600 has started reproduction of the program 1. When the sub-terminal 600 has received the decoding key, the content reproducing section 630 (i) accesses the content obtaining target URL included in the content use condition information received in advance, (ii) obtains encrypted content data of the program 1, and (iii) decodes the content data with use of the decoding key for reproduction of the program 1.

If the sub-license issuing/renewing section has determined that a sub-license is unavailable (NO in S3), the sub-license issuing/renewing section determines whether there is any service, other than the requested service, which should be suggested and for which a sub-license is issuable (S9).

If the sub-license issuing/renewing section has determined that there is such a service to be suggested (YES in S9), the sub-license issuing/renewing section causes the display section (not shown) of the sub-terminal 600 to display information on that service (S 10), and ends the process. If the sub-license issuing/renewing section has determined that there is no such service to be suggested (NO in S9), the sub-license issuing/renewing section causes the sub-terminal 600 to display an UI such as that in FIG. 28, and ends the sub-license issuing process.

(Operation Carried Out when Main Terminal 500 Switches Contents to be Reproduced (Main-License Content Switch Following Operation))

With reference to FIGS. 4, 5, 7, 21-24, and 29, the following description deals with an operation carried out by a main terminal 500 in the case where the main terminal 500, to which the main license “ID_001_full_01” has been issued, switches its reproducing content from the content “content_001” to the content “content_002”. The description below assumes that before the switch of the reproducing content, (i) a sub-terminal 600 to which the sub-license “ID_001_sub_01” has been issued synchronizes with the main terminal 500 and is reproducing the content “content_001”, and (ii) the license table includes the values of the license table S_L006.

The service use status change detecting section 520 of the main terminal 500 notifies the license authorization control section 530 that the content reproducing section 510 has started reproduction of the program 2 (S21).

The license authorization control section 530 records the switch of the reproducing content in the license table (S22). Specifically, the license authorization control section 530 changes the value of a “viewing content ID”, included in a class lower than the class of a “license ID” having the value “ID_001_full_01”, from “Content_001” to “Content_002”. The license authorization control section thus changes the values of the license table to the state of the license table S_L007 in FIG. 20.

The license authorization control section 530 checks (i) the use state for the license ID (“ID_001_full_01”) and (ii) details of a change to that use state in order to determine whether there is any associated license (S23). Specifically, the license authorization control section refers to the license table to check whether any “license ID” with the value “ID_001_full_01” is followed by a lower class including an “associated license ID”. The license table, which currently includes the values of the license table S_L007, includes associated license ID's with the respective values “ID_00 1_sub_01” and “ID_001_sub_02”.

If the license authorization control section has determined that there is no associated license (NO in S23), the license authorization control section ends the process.

If the license authorization control section has determined that there is an associated license as in the case of the license table including the values of the license table S_L007 (YES in S23), the license authorization control section 530 changes details of a service that can be provided to another terminal that is associated such as the sub-terminal 600 (S24). Specifically, the license authorization control section carries out an operation in S51 of (c) of FIG. 5 to record, in the license table, information indicating that another terminal to which the license indicated by the associated license ID has been issued is permitted to reproduce only the content “Content_002”. In other words, the license authorization control section changes the value of a “synchronized content ID” to “Content_002” for, among “constraints” with a “license ID” of “ID_001_sub_01”, the “constraint” having a “synchronized license ID” of “ID_001_full_01”. The license authorization control section thus changes the values of the license table to the state of the license table S_L008 in FIG. 21.

The above step in S24 concludes the processing carried out by the main terminal 500 in the case where the main terminal 500 has switched its reproducing content.

The following describes, with reference to FIG. 3, an operation carried out by the main terminal 500 when a license issued to the sub-terminal 600 has become close to its expiration time.

The license renewing section 620 of the sub-terminal 600, when the license has become close to its expiration time, transmits to the main terminal 500 a license renewal request, that is, a request to renew the sub-license (“ID_001_sub_01”) held by the sub-terminal itself. The sub-license issuing/renewing section 540 of the main terminal 500 thus receives the license renewal request (S1).

The sub-license issuing/renewing section 540, in response, refers to the service use status for the sub-license of “ID_001_sub_01” (S2). The sub-license issuing/renewing section 540, on the basis of the service use status that it has referred to, determines whether the sub-license requested is renewable and issuable (S3). If the sub-license issuing/renewing section has determined that the sub-license requested is not renewable and issuable (NO in S3), the sub-license issuing/renewing section proceeds to the step S9. The step S9 and its subsequent steps are similar to those carried out during the sub-license issuing operation. The following thus omits a description thereof.

If the license issuing/renewing section has determined that the sub-license requested is renewable and issuable (YES in S3), the sub-license issuing/renewing section 540 determines whether there has been any change to the license authorization since the immediately previous issue of the license. If the sub-license issuing/renewing section has determined that there has been such a change, the sub-license issuing/renewing section 540 (i) issues a renewed sub-license to the sub-terminal 600 and (ii) notifies the sub-terminal 600 that the content reproducible on the basis of the sub-license has been changed to the content (program 2) with the content ID “Content_002” (S9). The sub-license issuing/renewing section then ends the process. If the sub-license issuing/renewing section has determined that there has been no such change, the sub-license issuing/renewing section 540 carries out only the processing of issuing a renewed sub-license to the sub-terminal 600. The steps S5 through S8 are carried out for issue of a new license, and are not carried out for issue of a renewed license.

When the sub-terminal 600 has received a notification during the step S9, the content reproducing section 630 ends the reproduction of the content “content_001” and causes a display section thereof to display a UI such as that in FIG. 33. If the user of the sub-terminal 600 has selected “Yes”, the content reproducing section 630 switches its reproducing content to the program 2, in which case the license provision system carries out an operation described below.

The content reproducing section 630 transmits, to the service provision server 300, a request for content use condition information for the program 2. The service providing section 310 of the service provision server 300, in return, transmits the content use condition information for the program 2 to the sub-terminal 600.

When the sub-terminal 600 has received the content use condition information, the content reproducing section 630 transmits to the service provision server 300 (i) the content ID “Content_002” included in the content use condition information and (ii) the license ID “ID_001_sub_01” in order to request the service provision server to issue a decoding key necessary to decode the “PROGRAM 2”.

The service providing section 310 of the service provision server 300, in response, reads from the content table 320 the decoding key for decoding the content data of the program 2, and transmits the decoding key to the sub-terminal 600. The service providing section further notifies the main terminal 500 that the sub-terminal 600 has started reproduction of the program 2. The content reproducing section 110 of the sub-terminal 100 (i) accesses the content obtaining target URL included in the content use condition information received in advance, (ii) obtains content data of the program 2, and (iii) reproduces the program 2.

The service use status change detecting section 520 of the main terminal 500, upon receipt of a notification, notifies the license authorization control section 530 that the sub-terminal 600 has started reproduction of the program 2 (S21).

The license authorization control section 530 records, in the license table, the switch of the content reproduced by the sub-terminal 600 for which the sub-license “ID_001_sub_01” has been renewed and to which it has been issued (S22). Specifically, the license authorization control section 530 changes the value of a “viewing content ID”, included in a class lower than the class of a “license ID” having the value “ID_001_sub_01”, from “Content_001” to “Content_002”. The license authorization control section thus changes the values of the license table to the state of the license table S_L009 in FIG. 22.

The license authorization control section 530 checks (i) the use state for the license ID (“ID_001_sub_01”) and (ii) details of a change to that use state in order to determine whether there is any associated license (S23). Specifically, the license authorization control section refers to the license table to check whether any “license ID” with the value “ID_001_sub_01” is followed by a lower class including an “associated license ID”. The license table, which currently includes the values of the license table S_L009, includes associated license ID's with the respective values “ID_001_full_01” and “ID_001_full_02”.

If the license authorization control section has determined that there is no associated license (NO in S23), the license authorization control section ends the process.

If the license authorization control section has determined that there is an associated license as in the case of the license table including the values of the license table S_L009 (YES in S23), the license authorization control section 530 records, in the license table of the obtained license table storing section 550, the switch of the content reproduced by the sub-terminal 600 for which a sub-license has been renewed and to which it has been issued (S24). Specifically, the license authorization control section carries out an operation in S81 of (f) of FIG. 5 in order to change, for “license ID's” with the values “ID_001_full_01” and “ID_001_full_02”, the value of a “viewing content ID” for an “associated license ID” of “ID_001_sub_01” to “Content_002”. The license authorization control section thus changes the values of the license table to the state of the license table S_L010 in FIG. 23.

The above step in S24 concludes the processing carried out by the main terminal 500 in the case where the sub-terminal 600 has switched its reproducing content.

(Advantage of Main Terminal 500)

As described above, the main terminal 500 (operation control device) controls the sub-terminal 600 on the basis of a license including a main license and a sub-license, the sub-license permitting the sub-terminal 600 to reproduce only a content that is identical to the content that is being reproduced by the main terminal 500 on the basis of the main license.

The service use status change detecting section 520 detects that the content reproducing section 510 has switched its reproducing content to the content “Content_002”. Further, when such a change is thus detected, the license authorization control section 530 changes the license table so that the value of a “synchronized content ID” in a “constraint” is set to “Content_002”. With this operation, the content reproducible by the sub-terminal 600 on the basis of a sub-license is changed to the content “Content_002”.

(Supplemental Remarks)

The embodiments above each describe the service provision server and the license server as separate devices. The present invention may, needless to say, be implemented with the service provision server and the license server as a single device.

The license server 400 may be arranged such that in the case where a communication section (not shown) of the license server has determined, by comparing (i) the IP address of a user terminal 100 to which a main license has been issued with (ii) the IP address of a user terminal 100 to which a corresponding sub-license has been issued, that the two IP addresses belong to an identical network, the license authorization control section 412 further limits the operation of the user terminal 100 to which the sub-license has been issued. In this case, the license authorization control section 412 updates the license table to tighten a “constraint” included in a class lower than the class of the “sub-license ID” indicative of the sub-license.

The communication section may alternatively receive information indicative of a communication period by (i) notifying a user terminal 100 requesting a sub-license to be issued of the IP address of a user terminal to which a main license has been issued and (ii) causing the user terminal 100 to measure a period of communication (for example, a response time of PING) with the user terminal to which the main license has been issued. The license authorization control section 412 may, also in the case where the communication period is equal to or longer than a predetermined period, limit the operation of the user terminal 100, to which a sub-license is to,be issued, as compared to the case in which the communication period is shorter than the predetermined period.

The license issuing/renewing section 420 of the license server 400 may control the service providing section 310 of the service provision server 300 so that a sub-terminal 100 is permitted to reproduce only a content point that is being reproduced by a main terminal 100. The license issuing/renewing section 420 may alternatively control the service providing section 310 of the service provision server 300 so that after starting reproduction of a content from its top, a sub-terminal 100 is (I) until the sub-terminal reaches a content point being reproduced by a main terminal 100, (i) permitted to reproduce the content at only a speed higher (for example, 1.5 times higher) than the speed of reproduction by the main terminal 100 or (ii) not permitted to carry out a trick reproduction, and (II) after the sub-terminal has reached the content point being reproduced by the main terminal 100, permitted to reproduce a content point that is being reproduced by the main terminal 100. This arrangement further limits the authorization and status for service use, based on the sub-license, by the sub-terminal 100, and will provide, as an additional service, a limited use that allows a user present near a main terminal 100 and the user's family member present near a sub-terminal 100 to view a content together.

In the case where the service provided is a streaming distribution of a content for which a sub-terminal 100 is permitted to reproduce only a point being reproduced by a main terminal 100, the license issuing/renewing section 420 can multicast a content to the main terminal 100 and the sub-terminal 100 simultaneously, and thus advantageously reduce the load on a network and on a content provision terminal. A similar advantage can be achieved by (i) causing the main terminal 100 to transfer its received content stream by a P2P method to the sub-terminal 100 and (ii) causing the sub-terminal 100 to reproduce the content stream thus transferred.

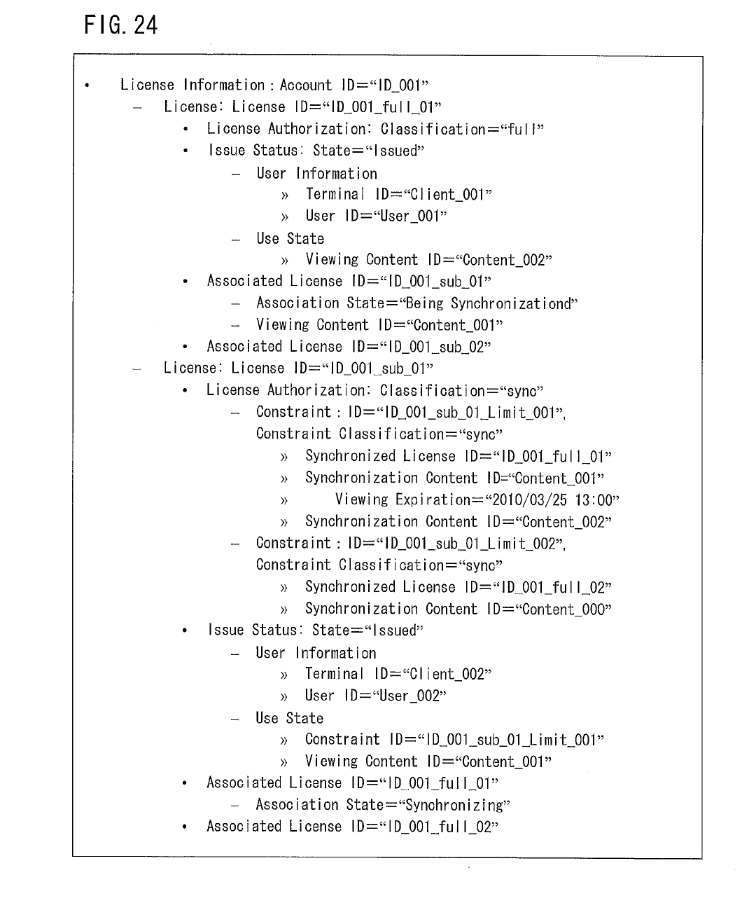

The present invention may be arranged such that when a main terminal 100 synchronizing with a sub-terminal 100 switches its reproducing content from the content “Content_001” to the content “Content_002”, the authorization of a sub-license to reproduce the content “Content_001” may be limited not immediately but after a wait provided to the expiration time. In this case, the license authorization control section 412 can simply update the values of the license table from the license table S_L007 to, not the license table S_L008, but the license table S_L008_2 in FIG. 24. Specifically, the license authorization control section can simply record a “viewing expiration” in a class lower than the class of a “synchronized content ID”. In the case where the viewing expiration is set to (i) a time point occurring a predetermined period after the service use status change detecting section 411 detects that the main terminal 100 has switched its reproducing content to “Content_002” or (ii) a time point at which reproduction will reach the end of the content “Content_001”, the sub-terminal is permitted to continue reproducing the content “Content_001” for such a predetermined period or until the end of the content “Content_001”.

The present invention may set an expiration time for a sub-license appropriately depending on the service to be provided. Specifically, the present invention desirably sets (i) a short expiration time in the case where a service available to a sub-terminal 100 needs to be controlled rapidly in correspondence with a service being used by a main terminal 100, and (ii) a long expiration time in order to reduce, for example, the load caused by a communication between the sub-terminal 100 and the license server 400 or the load caused to the license server 400 during its process of renewing a sub-license of the sub-terminal 100.

A license is issued and renewed through a process based on the server-client model, in which a user terminal 100 transmits a request to a license server 400, which then responds to the request. The license server 400 thus normally does not itself transmit, to a user terminal 100, a request for a communication connection. The present invention sets an expiration time for a sub-license in order to solve the problem that in the above case, a change to the authorization based on a sub-license cannot be reflected in a sub-terminal 100 rapidly. The license server 400 may alternatively, in response to a change to details of the authorization based on an associate license, notify a sub-terminal 100 rapidly to that effect to prompt the sub-terminal to switch its reproducing content before reaching the expiration time of the license.

The above arrangement is specifically achieved through the follows process: The license authorization control section 412, after changing the authorization of the license of ID_001_sub_01, determines whether it needs to stop or collect the sub-license provided to the sub-terminal 100. In this process, since the sub-terminal 100 has lost its authorization to reproduce the content “Content_001” being reproduced, the license authorization control section determines that it needs to stop or collect the sub-license. The license issuing/renewing section 420, if the license authorization control section has determined that it needs to stop or collect the sub-license, transmits to the sub-terminal 100 a request for an immediate license renewal. The sub-terminal 100, upon receipt of the immediate renewal request, starts a process of renewing the license. This arrangement, although requiring the sub-terminal 100 to appropriately receive an immediate renewal request transmitted by the license server 400 to change details of the license, can reduce a communication unnecessary for a license renewal, and can thus, while preventing an increase of the load on a communication process, carry out notifying and changing processes with high immediacy.

The license issuing/renewing section 420 can also carry out a forcible renewal process in which (i) when details of the authorization of a sub-license have been changed, the license issuing/renewing section notifies the service provision server 300 to that effect, and (ii) when the service provision server 300 has received the notification, the service providing section 310 of the service provision server simultaneously (i) stops the provision of a service to the sub-terminal 100 temporarily and (ii) forces the user to carry out a license renewal process. The above stop of the provision of a service refers, for example, to a process of temporarily blocking a streaming content in the service provision server 300 from being accessed by a sub-terminal 100 carrying out a streaming reproduction.

Carrying out such a forcible renewal process requires a service provided by the service provision server 300 to a user terminal 100 to be a service (for example, the above service of a streaming distribution of a content) that is provided through an intermittent access by the user terminal 100 to the service provision server 300. In other words, a license renewal process needs to be carried out by another method in the case where the service provision server 300 provides a user terminal 100 with a service (for example, a service of distribution of a download content to be stored in the user terminal 100) that can be provided even without an intermittent access by the user terminal 100 to the service provision server 300. Carrying out a forcible renewal process, which involves an intermittent access by a user terminal 100 to the service provision server 300, advantageously eliminates the need for the service provision server 300 to transmit to the user terminal 100 a request for a communication connection for a license renewal.

The description above deals with the license authorization control section 412 notifying, when a sub-license is issued, a user terminal 100 to which an associated license (main license) has been issued that a sub-terminal 100 has started synchronization reproduction. The license authorization control section 412 may, however, carry out such a notification at a timing other than the time of issue of a sub-license. Thus, the present invention may be arranged such that (i) the main license also has its expiration time set therefor and that (ii) the main terminal 100, each time the expiration time is reached, transmits to the license server 400 an inquiry about which user terminal (or its user) among user terminals (or users) to each of which an associated license (sub-license) has been issued has changed its reproducing content.

A user terminal may obtain encrypted content data from the service providing section 310 at a timing different from the timing at which the user terminal obtains a decoding key. Particularly for a VOD service, which is not a real-time broadcast, a user terminal may start obtaining content data at any timing. A user terminal may alternatively (i) store content data in advance in a readable physical device (storage section) such as a USB memory and an SD card, or (ii) receive content data through a streaming distribution.

The embodiments above each deal with a content reproduction as an example of an operation that a user terminal 100 can carry out on the basis of a main license and a sub-license. The content to be reproduced may be a music content or a video content. Further, the content may be obtained through a pay download or streaming distribute from the service provision server 300.

The embodiments above each describe (i) a main license as a license that permits reproduction of any content and (ii) a sub-license as a license that permits reproduction of only a content that is being reproduced by a user terminal to which the main license has been issued. In the case where there are N contents (N episodes) under an identical title as in a drama series, the sub-license may be a license that permits reproduction of only a content under a title identical to the title of a content being reproduced by a user terminal to which the main license has been issued.

The license servers 400 and 400′ may each issue a plurality of kinds of sub-licenses that are different from each other in range of a permitted operation (generally corresponding to n ranges U1 . . . Un where the inclusion relation U1 ⊂ U2 ⊂ . . . ⊂ Un is satisfied), the plurality of kinds of sub-licenses being, for example, (i) a license that permits reproduction of only a content under a title identical to the title of a content being reproduced by the main terminal and (ii) a license that permits reproduction of a content being reproduced by the main terminal. The license servers 400 and 400′ may, in the case where they are capable of issuing a plurality of kinds of sub-licenses, each issue, to a user terminal that has requested issue of a sub-license, preferentially a sub-license that is narrow in range of a permitted operation. Further, the license servers 400 and 400′ may each allow a user of the user terminal that has requested issue of a sub-license to select, from among the plurality of kinds of sub-licenses, a sub-license of which the user requests the issue.

A user terminal is permitted, on the basis of a main license and a sub-license, to carry out an operation of, not only a content reproduction, but possibly another operation such as VoIP communication, in which case a main license permits a user to call any destination and a sub-license permits a user to call a designated destination. The present invention is applicable to, not only a content distribution service, but any service in which the range of an operation permitted by a main license includes that of an operation permitted by a sub-license.

(Program and Recording Medium)

Finally, the components of the user terminal 100, the service provision server 300, and the license server 400 may be realized by way of hardware. However, each function of the following components may be realized, as described below, by way of software as executed by a CPU: the license dynamic control section 410 and the license issuing/renewing section 420 of the license server 400; the service providing section 310 of the service provision server 300; and the content reproducing section 110 and the license control section 120 of a user terminal 100.

The user terminal 100, the service provision server 300, and the license server 400 each include a CPU and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the user terminal 100, the service provision server 300, and the license server 400 a computer-readable recording medium containing the program code (executable program, intermediate code program, or source program) of respective control programs for the user terminal 100, the service provision server 300, and the license server 400, each of which is a software realizing the aforementioned functions, in order for the computer (or CPU, MPU) to retrieve and execute the program code contained in the recording medium.

The recording medium may be, for example, (i) a tape such as a magnetic tape and a cassette tape, (ii) a disc such as a magnetic disc (for example, a floppy (registered trademark) disc or a hard disc) and an optical disc (for example, a CD-ROM, an MO, an MD, a DVD, or a CD-R), or (iii) a card such as an IC card (memory card) and an optical card, or (iv) a semiconductor memory such as a mask ROM, an EPROM, an EEPROM, and a flash ROM.

The user terminal 100, the service provision server 300, and the license server 400 may be arranged connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (registered trademark), 802.11 wireless, HDR, mobile telephone network of generation 3.9 or later, satellite line, or terrestrial digital network. The present invention encompasses a mode of a computer data signal in which a carrier wave is embedded, the computer data signal in which the program code is embodied electronically.

(Recap)

As described above, the operation control device of the present invention may desirably be arranged such that in a case where the detecting means has detected that the first terminal has ended an operation within the prescribed range, the operation control means ends the operation within the partial range, the operation being carried out by the second terminal.

The operation control device may desirably be arranged such that the any operation within the prescribed range includes (i) an operation of reproducing a first content distributed by a content distribution server and (ii) an operation of reproducing a second content distributed by the content distribution server; the operation within the partial range includes an operation of reproducing a content being reproduced by the first terminal; and in a case where the detecting means has detected that the first terminal has ended the operation of reproducing the first content, the operation control means ends the operation, carried out by the second terminal, of reproducing the first content.

The operation control device may desirably be arranged such that in a case where the operation carried out after the switch having been detected by the detecting means is the operation of reproducing the second content, the operation control means causes the second terminal to reproduce the second content.

The above arrangement can further advantageously prevent a license provider from suffering from a disadvantage that in the case where the first terminal has started an operation of reproducing a second content, different contents are reproduced by the first terminal and the second terminal although they have merely been granted only one license.

The operation control device may desirably be arranged such that the second terminal is capable of reproducing a content through a normal reproduction and a trick reproduction; and in the case where the operation carried out after the switch having been detected by the detecting means is the operation of reproducing the second content, the operation control means causes the second terminal to first (i) reproduce the first content through the normal reproduction until an end of the first content and then (ii) reproduce the second content.

With the above arrangement, the operation control device further achieves an advantage of preventing a user's disadvantage that in the case where the user is viewing a first content at the second terminal, the switch of operations by the first terminal will immediately prevent the user from viewing the first content at the second terminal.

The operation control device may desirably be arranged such that the operation control means controls an operation of the second terminal so that the second terminal outputs information from an output section as a result of reproducing the second content, the information being identical to information that the first terminal outputs from an output section as a result of reproducing the second content.

The operation control device may desirably be arranged such that the operation control means controls the operation of the second terminal so that the information being outputted by the second terminal is constantly identical to the information being outputted from the output section of the first terminal.

The operation control device may desirably be arranged such that in a case where the information being outputted by the second terminal corresponds to a playback position of the second content which playback position is closer to a top of the second content than is a playback position of the second content to which playback position the information being outputted by the first terminal corresponds, the operation control means controls the second terminal so that the second terminal reproduces the second content at a speed higher than a speed at which the first terminal reproduces the second content.

The operation control device with each of the above arrangements can not only limit a content reproducible by the second terminal, but also limit a reproducible point in such a reproducible content. Thus, each arrangement above achieves a further advantage of better protecting the benefit for a content provider.

The operation control device may desirably be arranged such that in a case where the detecting means has detected that the first terminal carries out no operation within the prescribed range after the switch of the operations within the prescribed range, the operation control means controls an operation of the second terminal so that the second terminal is capable of carrying out any operation within the prescribed range.

With the above arrangement, the operation control device, in the case where the first terminal, which is permitted to carry out any operation within the prescribed range, carries out no operation within the prescribed range, permits the second terminal to carry out any operation within the prescribed range.

The above arrangement, in the case where the first terminal, which is permitted to carry out any operation within the prescribed range, carries out no operation, permits the second terminal to carry out any operation within the prescribed range. The above arrangement thus advantageously further improves users' convenience.

The operation control device may desirably be arranged such that the any operation within the prescribed range includes (i) an operation of reproducing a first content distributed by a content distribution server and (ii) an operation of reproducing a second content distributed by the content distribution server; and in the case where the detecting means has detected that the first terminal carries out no operation within the prescribed range after the switch of the operations within the prescribed range, the operation control means controls the second terminal so that the second terminal is capable of reproducing both the first content and the second content.

The operation control device may desirably be arranged such that the operation control means is arranged such that the partial range of the operation that the second terminal is permitted to carry out under the license is selectable, in accordance with the kind of the operation carried out after the switch by the first terminal, from among n ranges U1, U2, . . . , Un, where n is an integer of two or greater, the n ranges satisfying an inclusion relation U1 ⊂ U2 ⊂ . . . ⊂ Un.

With the above arrangement, the operation control device, in the case where, for instance, the operation permitted under the license is an operation of reproducing a content, achieves an advantage of appropriately changing, in accordance with a content provider's intention, the range of a content reproducing operation that the second terminal is permitted to carry out.

The operation control device may desirably further include: determining means for determining whether the first terminal and the second terminal belong in an identical network, the operation control means, in a case where the determining means has determined that the first terminal and the second terminal do not belong in the identical network, further limiting the partial range of the operation that the second terminal is permitted to carry out than in a case where the determining means has determined that the first terminal and the second terminal belong in the identical network.

The operation control device may desirably further include: determining means for determining whether a time period necessary for the first terminal to communicate with the second terminal is equal to or longer than a predetermined time period, the operation control means, in a case where the determining means has determined that the necessary time period is equal to or longer than the predetermined time period, further limiting the partial range of the operation that the second terminal is permitted to carry out than in a case where the determining means has determined that the necessary time period is not equal to or longer than the predetermined time period.

With each of the above arrangements, the operation control device, in the case where the second terminal is far from the first terminal in terms of network, further limits the range of an operation that the second terminal is permitted to carry out under the license. In the case where the second terminal is far from the first terminal in terms of network, the user of the second terminal may not be the same as the user of the first terminal; specifically, the user of a first terminal, who holds the license, may be allowing another user, such as a friend of the above user's, to use the license through a second terminal that the other user owns.

In view of the above situation, the operation control f device further limits, than the license use by a second terminal owned by a user who holds the license, the license use by a second terminal owned by another user such as a friend of the above user's.

Thus, with each of the above arrangements, the operation control device achieves an advantage of better protecting the benefit of a license provider.

The operation control device of the present invention may be one of (i) a license provision device for registering the license, (ii) the content distribution server, and (iii) the first terminal.

The present invention may be achieved in the form of a license provision system including: a content distribution server for distributing a content; and a license provision device for registering the license, the license provision device operating as the operation control device.

The present invention encompasses in scope (i) a program for operating an operation control device of the present invention, the program causing a computer to function as each of the means and (ii) a computer-readable recording medium containing the program.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### INDUSTRIAL APPLICABILITY

The present invention is applicable to any of various services provided over a network, such as a pay-content distribution service.

### REFERENCE SIGNS LIST

100 user terminal

110 content reproducing section

120 license control section

121 license obtaining section

122 license renewing section

300 service provision server

310 service providing section

320 service content table

330 user account table

400 license server (operation control device)

400′ license server (operation control device)

410 license dynamic control section

411 service use status change detecting section (detecting means)

412 license authorization control section (determining means)

420 license issuing/renewing section (operation control means)

430 license table storing section

440 license issuing section

500 main terminal

540 sub-license issuing/renewing section

550 obtained license table storing section

600 sub-terminal

1. An operation control device for controlling a first terminal and a second terminal, separate from the first terminal, on a basis of a license permitting (i) the first terminal to carry out any operation within a prescribed range and (ii) the second terminal to carry out, among said any operation, any operation within a partial range included in the prescribed range,
the operation control device comprising:
detecting means for detecting that the first terminal has switched operations within the prescribed range, the operations being carried out under the license; and
operation control means for, in accordance with a kind of the operation carried out after the switch having been detected by the detecting means, changing the partial range of the operation that the second terminal is permitted to carry out under the license.

2. The operation control device according to claim 1,
wherein:
in a case where the detecting means has detected that the first terminal has ended an operation within the prescribed range, the operation control means ends the operation within the partial range, the operation being carried out by the second terminal.

3. The operation control device according to claim 2,
wherein:
said any operation within the prescribed range includes (i) an operation of reproducing a first content distributed by a content distribution server and (ii) an operation of reproducing a second content distributed by the content distribution server;
the operation within the partial range includes an operation of reproducing a content being reproduced by the first terminal; and
in a case where the detecting means has detected that the first terminal has ended the operation of reproducing the first content, the operation control means ends the operation, carried out by the second terminal, of reproducing the first content.

4. The operation control device according to claim 3,
wherein:
in a case where the operation carried out after the switch having been detected by the detecting means is the operation of reproducing the second content, the operation control means causes the second terminal to reproduce the second content.

5. The operation control device according to claim 4,
wherein:
the second terminal is capable of reproducing a content through a normal reproduction and a trick reproduction; and
in the case where the operation carried out after the switch having been detected by the detecting means is the operation of reproducing the second content, the operation control means causes the second terminal to first (i) reproduce the first content through the normal reproduction until an end of the first content and then (ii) reproduce the second content.

6. The operation control device according to claim 4,
wherein:
the operation control means controls an operation of the second terminal so that the second terminal outputs information from an output section as a result of reproducing the second content, the information being identical to information that the first terminal outputs from an output section as a result of reproducing the second content.

7. The operation control device according to claim 6,
wherein:
the operation control means controls the operation of the second terminal so that the information being outputted by the second terminal is constantly identical to the information being outputted from the output section of the first terminal.

8. The operation control device according to claim 6,
wherein:
in a case where the information being outputted by the second terminal corresponds to a playback position of the second content which playback position is closer to a top of the second content than is a playback position of the second content to which playback position the information being outputted by the first terminal corresponds, the operation control means controls the second terminal so that the second terminal reproduces the second content at a speed higher than a speed at which the first terminal reproduces the second content.

9. The operation control device according to claim 1,
wherein:
in a case where the detecting means has detected that the first terminal carries out no operation within the prescribed range after the switch of the operations within the prescribed range, the operation control means controls an operation of the second terminal so that the second terminal is capable of carrying out any operation within the prescribed range.

10. The operation control device according to claim 9,
wherein:
said any operation within the prescribed range includes (i) an operation of reproducing a first content distributed by a content distribution server and (ii) an operation of reproducing a second content distributed by the content distribution server; and
in the case where the detecting means has detected that the first terminal carries out no operation within the prescribed range after the switch of the operations within the prescribed range, the operation control means controls the second terminal so that the second terminal is capable of reproducing both the first content and the second content.

11. The operation control device according to claim 1,
wherein:
the operation control means is arranged such that the partial range of the operation that the second terminal is permitted to carry out under the license is selectable, in accordance with the kind of the operation carried out after the switch by the first terminal, from among n ranges U1, U2, . . . , Un, where n is an integer of two or greater, the n ranges satisfying an inclusion relation U1 ⊂ U2 ⊂ . . . ⊂ Un.

12. The operation control device according to claim 11, further comprising:
determining means for determining whether the first terminal and the second terminal belong in an identical network,
the operation control means, in a case where the determining means has determined that the first terminal and the second terminal do not belong in the identical network, further limiting the partial range of the operation that the second terminal is permitted to carry out than in a case where the determining means has determined that the first terminal and the second terminal belong in the identical network.

13. The operation control device according to claim 11, further comprising:
determining means for determining whether a time period necessary for the first terminal to communicate with the second terminal is equal to or longer than a predetermined time period,
the operation control means, in a case where the determining means has determined that the necessary time period is equal to or longer than the predetermined time period, further limiting the partial range of the operation that the second terminal is permitted to carry out than in a case where the determining means has determined that the necessary time period is not equal to or longer than the predetermined time period.

14. The operation control device according to claim 1,
wherein:
the operation control device is one of (i) a license provision device for registering the license, (ii) a content distribution server for distributing a content, and (iii) the first terminal.

15. A license provision system comprising:
a content distribution server for distributing a content; and
a license provision device for registering the license, the license provision device operating as the operation control device according to claim 1.

16. An operation control method carried out by an operation control device for controlling a first terminal and a second terminal, separate from the first terminal, on a basis of a license permitting (i) the first terminal to carry out any operation within a prescribed range and (ii) the second terminal to carry out, among said any operation, any operation within a partial range included in the prescribed range,
the operation control method comprising:
a detecting step for detecting that the first terminal has switched operations within the prescribed range, the operations being carried out under the license; and
an operation control step for, in accordance with a kind of the operation carried out after the switch having been detected in the detecting step, changing the partial range of the operation that the second terminal is permitted to carry out under the license.

17. (canceled)

18. A computer-readable non-transitory recording medium containing a program for operating the operation control device according to claim 1, wherein the program causes a computer to function as the means.
